(19) United States
(12) Patent Application Publication
(10) Pub. No.: US 2010/0027492 A1
(43) Pub. Date: Feb. 4, 2010

(54) WIRELESS BASE STATION APPARATUS AND MOBILE WIRELESS TERMINAL APPARATUS

(75) Inventor: Yutaka ASANUMA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/512,199

(22) Filed: Jul. 30, 2009

(30) Foreign Application Priority Data
Jul. 31, 2008 (JP) 2008-198745

(51) Int. Cl. H04W 72/04

(52) U.S. Cl. 370/329

(57) ABSTRACT

In the downlink, the channel band at each end of three 20-MHz channel bands has the DC subcarrier at its center at a position spaced apart from the DC subcarrier of the middle channel band by 18.015 MHz or more and, more specifically, by 18.3 MHz corresponding to a spacing of 300 kHz that is the least common multiple of the 100-kHz channel raster and the 15-kHz subcarrier spacing. The subcarriers at the two ends are rearranged between the channel bands.

### CROSS-REFERENCE TO RELATED APPLICATIONS

This application is based upon and claims the benefit of priority from prior Japanese Patent Application No. 2008-198745, filed Jul. 31, 2008, the entire contents of which are incorporated herein by reference.

### BACKGROUND OF THE INVENTION

1. Field of the Invention

The present invention relates to communication between a wireless base station apparatus and a mobile wireless terminal apparatus which are accommodated in a network.

2. Description of the Related Art

A mobile communication system such as a cellular system uses various parameters for defining the transmission/reception capability of a terminal to support terminals of various application purposes (e.g., 3GPP (3rd Generation Partnership Project) TS 36.306 V8.2.0 (2008-05)). Combinations of parameters define UE categories. Terminal capabilities (UE capabilities) that define the UE categories include a maximum information transmission rate which is defined on each of the transmitting and receiving sides. A base station transmits/receives signals to/from a plurality of terminals based on their different transmission and reception capabilities. The 3GPP (3rd Generation Partnership Project) TS 36.306 V8.2.0 (2008-05) suggests that a base station should be able to simultaneously connect terminals of different categories.

To operate a system for transmitting/receiving broadband and narrowband signals using a single band, the system needs to have a multi-carrier configuration. The transmitting side transmits all carriers, whereas the receiving side changes the number of received carriers in accordance with the reception bandwidth (e.g., 3GPP2 (3rd Generation Partnership Project 2) C.S0002-D v2.0).

3GPP (3rd Generation Partnership Project) TS 36.104 V8.2.0 (2008-05) 5.2 shows the relation between channel bandwidths and the transmission bandwidths. A wireless communication system assigns a use bandwidth as a channel bandwidth. However, the bandwidth of a signal to be transmitted is separately defined as a transmission bandwidth because of restrictions on the design of transmission and reception filters. The transmission bandwidth is usually narrower than the channel bandwidth. The difference serves as a guard band. The existence of the guard band enables to practically implement a filter for limiting adjacent channel leakage power on the transmitting side and also practically implement a filter for obtaining adjacent channel selectivity on the receiving side.

The standard described in 3GPP (3rd Generation Partnership Project) TS 36.104 V8.2.0 (2008-05) 5.2 mentions “transmission bandwidth configuration” in comparison with partial bands sometimes used for transmission. When a base station or the like transmits all carriers in a normal operation, the transmission bandwidth configuration equals the transmission bandwidth. When the channel bandwidth is 20 MHz, the transmission bandwidth is 18 MHz (=100 RB). When the channel bandwidth is 10 MHz, the transmission bandwidth is 9 MHz (=50 RB). That is, the relation between the channel bandwidth and the transmission bandwidth is defined not by a difference but by a ratio. This is because the filter characteristic is proportional to the cutoff frequency, and the bandwidth of the passband of a signal is proportional to a frequency bandwidth at which attenuation amount reaches a predetermined value.

A terminal in a system having a plurality of carrier center frequencies, like a cellular phone, searches for an operating base station based on a predetermined channel raster. The channel raster is a range where the carrier center frequency of a wireless communication system is arranged (e.g., 3GPP (3rd Generation Partnership Project) TS 36.101 V8.2.0 (2008-05) 5.4.3). Defining the channel raster is a common practice because of the advantage of reducing the number of candidates of operating systems to be searched for and in the viewpoint of practically constituting a synthesizer that generates the carrier frequency of an apparatus.

The standard described in 3GPP (3rd Generation Partnership Project) TS 36.101. V8.2.0 (2008-05) 5.4.3 defines the channel raster at a spacing corresponding to an integer multiple of 100 kHz. That is, the carrier center frequency is preferably an integer multiple of a given reference frequency in view of the apparatus configuration. In an OFDM system, the center subcarrier corresponding to 0 Hz in a signal frequency-converted by a receiver is hard to ensure the signal-to-noise ratio S/N. Hence, the subcarrier called a DC subcarrier is not used to transmit a signal in a general configuration. The receiver extracts no received signal from the DC subcarrier.

In a system which operates mobile wireless terminal apparatuses for receiving different channel bandwidths in a single frequency band, conventionally, the base station needs to transmit signals such that the mobile wireless terminal apparatuses using the narrow reception channel bandwidths can receive the signals in a satisfactory characteristic. A multi-carrier system based on a frequency bandwidth equal to or less than the narrow channel bandwidth can easily cope with the plurality of reception channel bandwidths. However, since the channel raster restricts transmission signal setting, it is difficult to effectively utilize the bandwidths.

### BRIEF SUMMARY OF THE INVENTION

The present invention has been made to solve the above problem, and has as its object to provide a wireless base station apparatus and a mobile wireless terminal apparatus, which can prevent any degradation in the reception characteristic of a mobile wireless terminal apparatus using a narrow reception channel bandwidth and effectively utilize the bandwidths.

To achieve the object, an aspect of the present invention is a wireless base station apparatus which wirelessly communicates with a plurality of mobile wireless terminal apparatuses via channel bands including a plurality of subcarriers. The wireless base station comprises a detection unit which detects a communication capability from data received from a mobile wireless terminal apparatus; a channel assigning unit which selectively assigns, to the mobile wireless terminal apparatus, one or three of a first channel band, a second channel band, and a third channel band in accordance with a detection result of the detection unit; and a wireless transmission unit which performs wireless transmission to the mobile wireless terminal apparatus via the channel band assigned by the channel assigning unit, wherein the first channel band is arranged so as to locate a DC subcarrier on a channel raster, the second channel band is arranged so as to be adjacent to the first channel band from a high frequency side and locate a DC subcarrier on the channel raster while arranging subcarriers in number asymmetrical with respect to the DC subcarrier, and the third channel band is arranged so as to be adjacent to the first channel band from a low frequency side and locate a DC subcarrier on the channel raster while arranging subcarriers in number asymmetrical with respect to the DC subcarrier.

As described above, in the present invention, when assigning the first channel band, the second channel band, and the third channel band to the mobile wireless terminal apparatus, the second channel band and the third channel band which are adjacent to the first channel band are arranged such that the subcarriers are arranged in number asymmetrical with respect to the DC subcarrier.

Hence, according to the present invention, in each of the second channel band and the third channel band adjacent to the first channel band, the subcarrier arrangement is asymmetrical with respect to the DC subcarrier. This makes it possible to set the DC subcarrier at a position adaptive to the channel raster and the subcarrier spacing.

It is therefore possible to provide a wireless base station apparatus and a mobile wireless terminal apparatus, which can prevent any degradation in the reception characteristic of a mobile wireless terminal apparatus using a narrow reception channel bandwidth (first channel band) and effectively utilize the bandwidths by operating three adjacent channel bands.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a circuit block diagram showing the arrangement of a mobile wireless terminal apparatus according to an embodiment of the present invention;

FIG. 2 is a circuit block diagram showing the arrangement of a base station apparatus according to an embodiment of the present invention;

FIG. 3 is a view for explaining a subcarrier arrangement according to Example 1 of the present invention;

FIG. 4 is a view for explaining the structure of a resource block;

FIG. 5 is a view for explaining a subcarrier arrangement according to Example 1 of the present invention;

FIG. 6 is a view for explaining a subcarrier arrangement according to an example of the present invention;

FIG. 7 is a view showing an example of the structure of the transmission signal of one subframe;

FIG. 8 is a view for explaining a subcarrier arrangement according to Example 2 of the present invention;

FIG. 9 is a view showing a state in which subcarriers are divided into resource blocks;

FIG. 10 is a view showing a state in which subcarriers are divided into resource blocks;

FIG. 11 is a view for explaining a modification of the subcarrier arrangement according to Example 2 of the present invention;

FIG. 12 is a view for explaining a subcarrier arrangement according to Example 3 of the present invention;

FIG. 13 is a view for explaining a modification of the subcarrier arrangement according to Example 3 of the present invention;

FIG. 14 is a view for explaining a subcarrier arrangement according to Example 4 of the present invention;

FIG. 15 is a view for explaining a subcarrier arrangement according to Example 5 of the present invention;

FIG. 16 is a view for explaining a modification of the subcarrier arrangement according to Example 5 of the present invention;

FIG. 17 is a view for explaining a subcarrier arrangement according to Example 6 of the present invention; and

FIG. 18 is a view for explaining a modification of the subcarrier arrangement according to Example 6 of the present invention.

### DETAILED DESCRIPTION OF THE INVENTION

An embodiment of the present invention will now be described with reference to the accompanying drawing.

The arrangements of a mobile wireless terminal apparatus and a wireless base station apparatus according to the embodiment of the present invention will be described first.

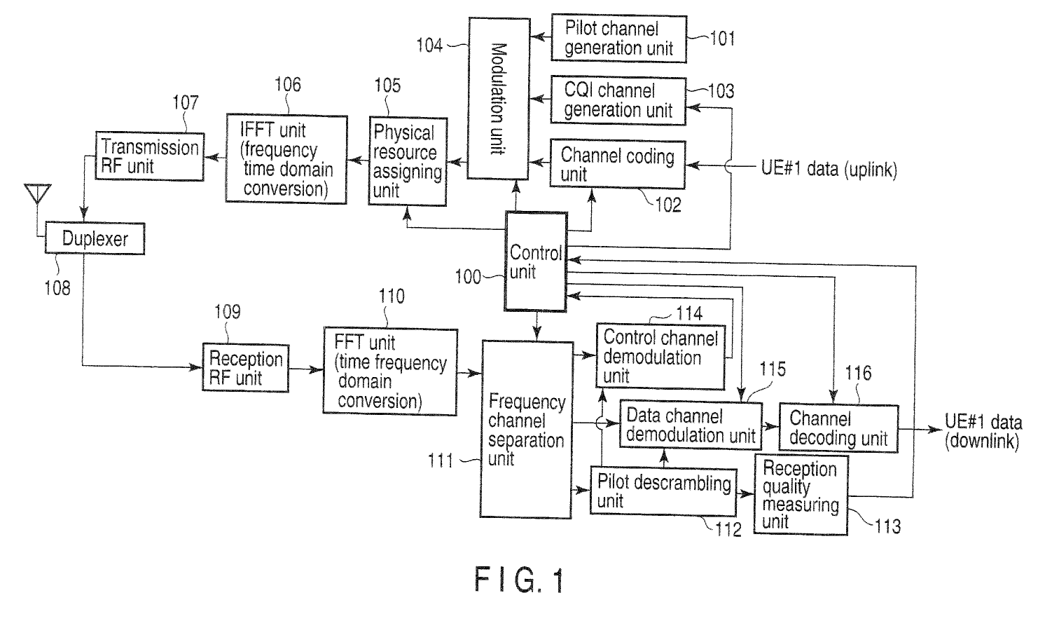

FIG. 1 shows the arrangement of the mobile wireless terminal apparatus of a wireless communication system according to the embodiment of the present invention.

A pilot channel generation unit 101 generates a bitstream that is the base of a reference signal to be transmitted via a pilot channel. The bitstream is scrambled and then output to a modulation unit 104. A CQI channel generation unit 103 generates a bitstream of CQI information sent from a control unit 100 and outputs it to the modulation unit 104. Note that the CQI channel generation unit 103 can also channel-code the CQI information. A channel coding unit 102 channel-codes a bitstream of uplink transmission data at a channel coding rate designated by the control unit 100 and outputs it to the modulation unit 104.

In accordance with a modulation method designated by the control unit 100, the modulation unit 104 performs digital modulation such as QPSK (Quadrature Phase Shift Keying) for the bitstreams which are the base of a reference signal, CQI information, and a channel-coded uplink transmission data signal, thereby generating a reference signal, a CQI signal, and a transmission data signal. Note that before data reception from the wireless base station apparatus, the UE capabilities of the mobile wireless terminal apparatus are input from the control unit 100 to the modulation unit 104 and transmitted to the wireless base station apparatus.

A physical resource assignment unit 105 assigns the generated reference signal and transmission data signal to subcarriers designated by the control unit 100. “Assigning a signal to a subcarrier” indicates adding, to a signal expressed by a complex value, a subcarrier index representing the position on the time and frequency axes of a subcarrier in a corresponding resource block.

An IFFT (Inverse Fast Fourier Transform) unit 106 converts a frequency-domain signal output from the physical resource assignment unit 105 into a time-domain signal. A transmission RF unit 107 including a D/A converter, an up-converter, and a power amplifier converts the signal into a radio (RF) signal. The radio signal is emitted, via a duplexer 108 and an antenna, into the space for the wireless base station apparatus.

The antenna receives a radio signal transmitted from the wireless base station apparatus and outputs it to a reception RF unit 109 via the duplexer 108. The reception RF unit 109 including a down-converter and an A/D converter converts the received radio signal into a baseband digital signal.

An FFT (Fast Fourier Transform) unit 110 performs fast Fourier transform of the baseband digital signal, thereby converting the time-domain signal into a frequency-domain signal, i.e., dividing the signal into subcarrier signals. The divided subcarrier signals are output to a frequency channel separation unit 111. Note that the wireless base station apparatus puts a predetermined number of (e.g., 12) subcarriers together into a resource block. The wireless base station apparatus assigns the subcarriers to the mobile wireless terminal apparatus for each resource block.

As for a channel band and a resource block designated by the control unit 100, the frequency channel separation unit 111 separates the subcarrier signals included in the resource block into a reference signal, control channel signals, and data signals.

Regarding how to divide a channel band into resource blocks, i.e., how to put subcarriers together into resource blocks, the wireless base station apparatus and the mobile wireless terminal apparatus have a consensus based on an arrangement made in advance. More specifically, the mobile wireless terminal apparatus perceives in advance how the wireless base station apparatus divides a channel band into resource blocks, and receives signals accordingly. Channel band assignment to radio signals to be transmitted from the wireless base station apparatus, division of a channel band into resource blocks (how to put subcarriers together into resource blocks), and the subcarrier arrangement on the frequency axis will be described later in detail as examples.

A pilot descrambling unit 112 descrambles the reference signal using a descrambling pattern opposite to the scrambling pattern used by the wireless base station apparatus which transmits the signal to be received by the mobile wireless terminal apparatus. The descrambling result is output to a control channel demodulation unit 114, a data channel demodulation unit 115, and a reception quality measuring unit 113. The reception quality measuring unit 113 measures the reception quality of Ncqi resource blocks. The measurement result is output to the control unit 100.

The control channel demodulation unit 114 performs channel equalization of control channel signals (PCFICH, PDCCH, and PHICH) output from the frequency channel separation unit 111 using the reference signal descrambled by the pilot descrambling unit 112 and then demodulates them. The demodulated control channel bitstreams are output to the control unit 100.

The control unit 100 comprehensively controls the units of the mobile wireless terminal apparatus. The control unit 100 detects, based on the information contained in the control channels, the channel band and the resource block assigned to the mobile wireless terminal apparatus. The control unit 100 then controls the units (e.g., frequency channel separation unit 111) of the reception system to receive data from the wireless base station apparatus via the channel band and the resource block. Upon determining that the received signal is addressed to the mobile wireless terminal apparatus, the control unit 100 extracts signaling information contained in the signal and detects, from it, information necessary for demodulating data channel signals and information necessary for decoding them.

The information necessary for demodulating the data channel signals is output to the data channel demodulation unit 115. The information necessary for decoding the data channel signals is output to a channel decoding unit 116. Upon determining that the received signal is not addressed to the mobile wireless terminal apparatus, the control unit 100 stops the processing of demodulating and decoding the data channel signals.

The data channel demodulation unit 115 performs channel equalization of the signals output from the frequency channel separation unit 111 using the reference signal output from the pilot descrambling unit 112. The data channel demodulation unit 115 then demodulates the signals based on a demodulation method designated by the control unit 100 and information output from it. The channel decoding unit 116 decodes the demodulated data bitstreams to obtain a downlink data bitstream for the mobile wireless terminal apparatus. Decoding here uses the information output from the control unit 100.

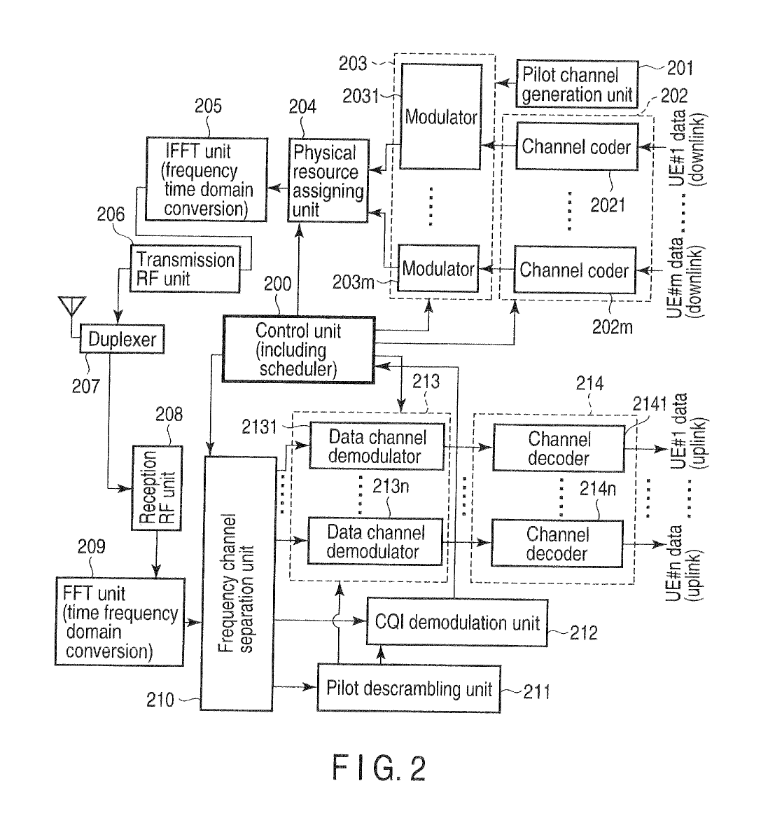

FIG. 2 shows the arrangement of the wireless base station apparatus of the wireless communication system according to the embodiment of the present invention.

A pilot channel generation unit 201 generates a bitstream that is the base of a reference signal to be transmitted via a pilot channel. The bitstream is scrambled and then output to a modulation unit 203. A channel coding unit 202 includes channel coders 2021 to 202m. The channel coders 2021 to 202m channel-code bitstreams of downlink transmission data at a channel coding rate designated by a control unit 200 and output them to the modulation unit 203.

The modulation unit 203 includes modulators 2031 to 203m corresponding to the channel coders 2021 to 202m, respectively. In accordance with a modulation method designated by the control unit 200, the modulators 2031 to 203m perform digital modulation such as QPSK (Quadrature Phase Shift Keying) for the bitstreams which are the base of a reference signal and a channel-coded downlink transmission data signal, thereby generating a reference signal and a transmission data signal.

A physical resource assigning unit 204 assigns the generated reference signal and transmission data signal to subcarriers (resource blocks) designated by the control unit 200. With this processing of the physical resource assigning unit 204, signals for the mobile wireless terminal apparatus are assigned to subcarriers (resource blocks) in a channel band assigned to the mobile wireless terminal apparatus. “Assigning a signal to a subcarrier” indicates adding, to a signal expressed by a complex value, a subcarrier index representing the position on the time and frequency axes of a subcarrier in a corresponding resource block.

Note that the channel band transmitted from the wireless base station apparatus is divided into resource blocks each including a plurality of subcarriers. In other words, every preset number of (e.g., 12) subcarriers arranged in each channel band are put together into a resource block. This configuration is commonly set in advance between the wireless base station apparatus and many mobile wireless terminal apparatuses. In the wireless base station apparatus, the control unit 200 and the physical resource assigning unit 204 implement it. The subcarrier arrangement on the frequency axis and division of a channel band into resource blocks by the control unit 200 and the physical resource assigning unit 204 will be described later in detail as examples.

An IFFT (Inverse Fast Fourier Transform) unit 205 converts a frequency-domain signal output from the physical resource assigning unit 204 into a time-domain signal. A transmission RF unit 206 including a D/A converter, an up-converter, and a power amplifier converts the signal into a radio (RF) signal. The radio signal is emitted, via a duplexer 207 and an antenna, into the space for the mobile wireless terminal apparatus.

The antenna receives a radio signal transmitted from the mobile wireless terminal apparatus and outputs it to a reception RF unit 208 via the duplexer 207. The reception RF unit 208 including a down-converter and an A/D converter converts the received radio signal into a baseband digital signal.

An FFT (Fast Fourier Transform) unit 209 performs fast Fourier transform of the baseband digital signal, thereby converting the time-domain signal into a frequency-domain signal, i.e., dividing the signal into subcarrier signals. The divided subcarrier signals are output to a frequency channel separation unit 210.

In accordance with an instruction from the control unit 200, the frequency channel separation unit 210 separates the divided subcarrier signals into a reference signal, CQI signals, and data signals.

A pilot descrambling unit 211 descrambles the reference signal using a descrambling pattern opposite to the scrambling pattern used by the mobile wireless terminal apparatus which transmits the signal to be received by the wireless base station apparatus. The descrambling result is output to a CQI demodulation unit 212 and a data channel demodulation unit 213.

The CQI demodulation unit 212 performs channel equalization of CQI signals output from the frequency channel separation unit 210 using the reference signal descrambled by the pilot descrambling unit 211 and then demodulates them. The CQI demodulation unit 212 also channel-decodes the demodulated CQI signals, extracts CQI information sent from the mobile wireless terminal apparatus, and outputs it to the control unit 200.

The data channel demodulation unit 213 includes a plurality of data channel demodulators 2131 to 213n. The data channel demodulators 2131 to 213n perform channel equalization of the signals output from the frequency channel separation unit 210 using the reference signal output from the pilot descrambling unit 211. The data channel demodulators 2131 to 213n then demodulate the signals based on a demodulation method designated by the control unit 200 and information output from it. The demodulated data bitstreams are output to a channel decoding unit 214.

The channel decoding unit 214 includes channel decoders 2141 to 214n corresponding to the data channel demodulators 2131 to 213n, respectively. The channel decoders 2141 to 214n decode the data bitstreams demodulated by the data channel demodulators 2131 to 213n to obtain uplink data bitstreams sent from the mobile wireless terminal apparatus. Decoding here uses the information output from the control unit 200.

The control unit 200 comprehensively controls the units of the wireless base station apparatus. The control unit 200 includes a scheduler which decides, for each frame, which channel band should be assigned to which mobile wireless terminal apparatus and the packet to be used for transmission, based on, e.g., feedback information (CQI information or Ack/Nack of a reception response) from each mobile wireless terminal apparatus, the amount of data for each mobile wireless terminal apparatus, and the priority and capabilities (UE capabilities) of each mobile wireless terminal apparatus.

The physical resource assigning unit 204 multiplexes data for a plurality of mobile wireless terminal apparatuses by OFDM in accordance with the decision of the scheduler. Note that the capabilities (UE capabilities) of a mobile wireless terminal apparatus are detected by the control unit 200 from data received from the mobile wireless terminal apparatus. Each mobile wireless terminal apparatus receives information representing the channel band assigned to it via a plurality of subcarrier control signals (PCFICH, PDCCH, and PHICH).

A subcarrier arrangement on the frequency axis in a radio signal (downlink) from the wireless base station apparatus to the mobile wireless terminal apparatus will be described next. The control unit 200 and the physical resource assigning unit 204 arrange the subcarriers. This will be explained below in detail.

### Example 1

In Example 1, an OFDM cellular system will be exemplified which operates, in a single 100-MHz frequency band, a mobile wireless terminal apparatus A capable of receiving a maximum channel bandwidth of 20 MHz and a mobile wireless terminal apparatus B capable of receiving a channel bandwidth of 100 MHz.

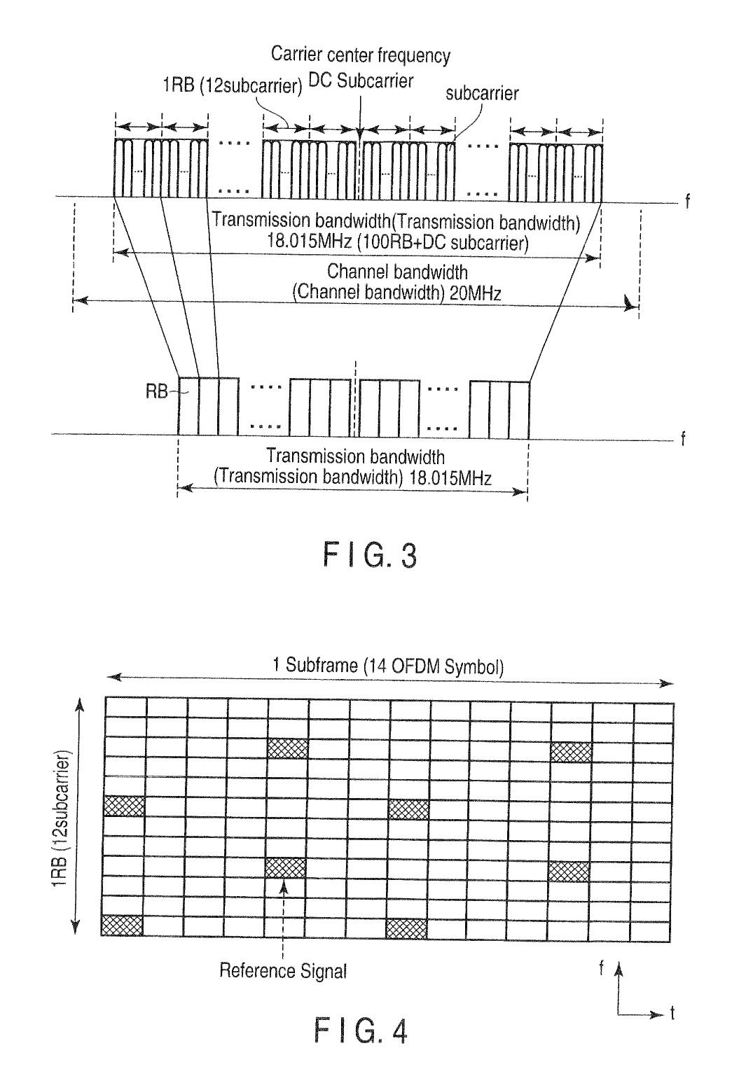

The mobile wireless terminal apparatus A can receive a channel band as shown in FIG. 3. More specifically, 100 RBs (resource blocks) each including 12 subcarriers at a subcarrier spacing of 15 kHz and having a bandwidth of 180 kHz are arranged in one transmission signal having a channel bandwidth of 20 MHz transmitted from the wireless base station apparatus. A DC subcarrier is arranged at the center frequency, thereby forming a transmission signal band of 18.015 MHz (the number of subcarriers=1201). Note that the DC subcarrier is not transmitted.

The difference between the channel bandwidth of 20 MHz and the transmission signal band of 18.015 MHz, i.e., 1.985 MHz (0.9925 MHz on each side) serves as a guard band which is not used to transmit signals considering the design of element components such as transmission and reception filters that are hard to obtain ideal characteristics. Note that the system description may regard the transmission bandwidth as 18 MHz and the guard bandwidth as 2 MHz (1 MHz on each side) excluding the DC subcarrier.

For the mobile wireless terminal apparatus A, one or more RBs are assigned to receive PDSCH within the 20-MHz channel bandwidth. FIG. 4 shows the structure of an RB (resource block). As shown in FIG. 4, an RB includes 12 subcarriers in the frequency direction and 14 symbols in the time direction. Reference signals which are known signals as the reference of a received signal are inserted.

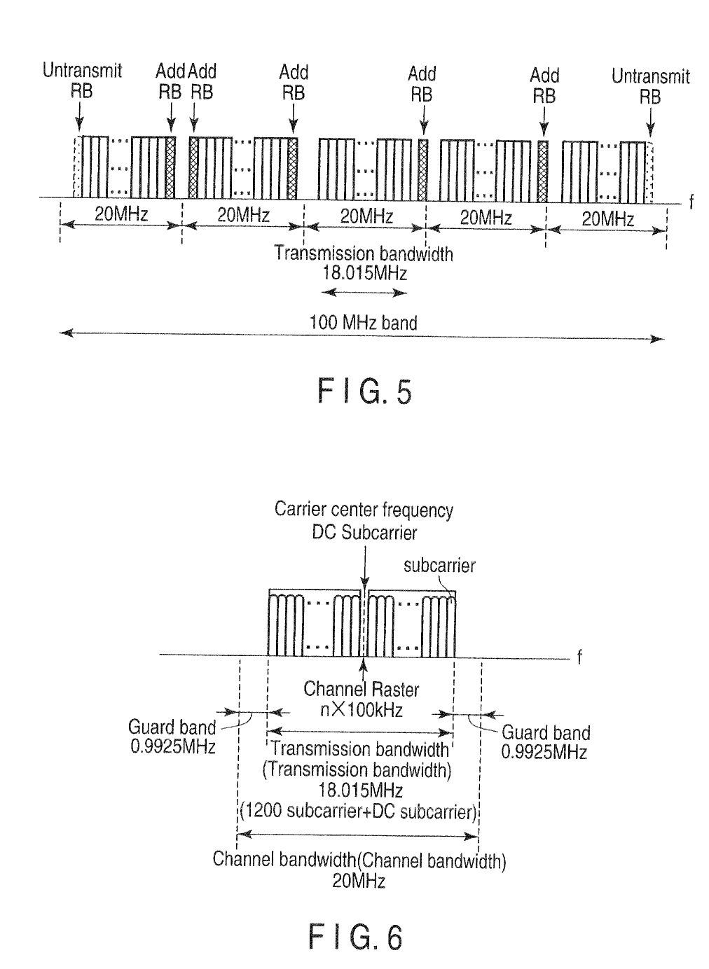

The mobile wireless terminal apparatus B can receive a channel bandwidth of 100 MHz as shown in FIG. 5. The wireless base station apparatus transmits a channel bandwidth of 100 MHz, as shown in FIG. 5. More specifically, the wireless base station apparatus arranges five transmission signals each having a channel bandwidth of 20 MHz in the frequency direction, thereby forming a channel bandwidth of 100 MHz in total. The 20-MHz signals have gaps between them, and new RBs are arranged there. To the mobile wireless terminal apparatus B, a control unit 200 and a physical resource assigning unit 204 assign one or more RBs to receive PDSCH within the 100-MHz channel bandwidth. For the mobile wireless terminal apparatus A, the control unit 200 and the physical resource assigning unit 204 set one of the five channel bandwidths as the reception range and assign one or more RBs to receive PDSCH within the 20-MHz channel bandwidth.

The guard band necessary for easily implementing devices such as a transmission filter and a reception filter is proportional to the signal bandwidth. For this reason, when transmitting or receiving a signal of 100-MHz band, the guard bands at the two ends of the band narrow. The guard bands are ensured by inhibiting assignment of several RBs at the two ends of the 100-MHz band not to transmit signals.

The mobile wireless terminal apparatus B needs to add only a few components to receive the RBs additionally arranged in the transmission signal. In the mobile wireless terminal apparatus B, a fast Fourier transform unit 110 converts a received OFDM signal from the time domain into the frequency domain. This processing is DFT (Discrete Fourier Transform) which is implemented by FFT (Fast Fourier Transform) to reduce the process amount.

FFT generally has a size corresponding to a power of 2. When the number of subcarriers is 1,201, conversion is done using FFT at least at 2,048 (2̂11) points. The sampling frequency is 15 kHz×2048=30.72 MHz at minimum. Hence, up to 2,048 subcarriers are receivable on FFT.

The actually receivable bandwidth is determined by the characteristic of a reception filter. It is not difficult to implement a reception filter required to receive the channel band of about 20 MHz relative to the original reception bandwidth of 18.015 MHz. However, to receive the added RBs by this method, the subcarriers need to be arranged at the same spacing as the original subcarrier spacing of 15 kHz.

The fast Fourier transform unit 110 divides the subcarriers including the added RBs shown in FIG. 5 into subcarrier signals. A frequency channel separation unit 111 separates the divided subcarrier signals into a reference signal, control channel signals, and data signals in accordance with an instruction from a control unit 100. The mobile wireless terminal apparatus thus receives the assigned subcarriers including the added RBs.

According to the wireless base station apparatus and the mobile wireless terminal apparatuses A and B having the above arrangements, it is possible to prevent any degradation in the reception characteristic of the mobile wireless terminal apparatus A which has the narrow reception channel bandwidth of 20 MHz. Additionally, the mobile wireless terminal apparatus B for receiving a wide bandwidth of 100 MHz can effectively utilize the 100-MHz bandwidth and also implement an arrangement required for this by adding only a few components.

In this example, addition of RBs and inhibition of RB assignment are implemented in unit of RB. These can also be implemented in unit of subcarrier. The OFDM signals each having a channel bandwidth of 20 MHz are arranged at a spacing of 20 MHz. However, the spacing can take any value equal to or larger than the transmission bandwidth of 18.015 MHz.

### Example 2

In Example 2, an OFDM cellular system will be exemplified which operates, in a single 60-MHz frequency band, a mobile wireless terminal apparatus A capable of receiving a maximum channel bandwidth of 20 MHz and a mobile wireless terminal apparatus B capable of receiving a channel bandwidth of 60 MHz.

The mobile wireless terminal apparatus A can receive a channel band as shown in FIG. 6. More specifically, 1,200 subcarriers at a subcarrier spacing of 15 kHz are arranged in one transmission signal having a channel bandwidth of 20 MHz transmitted from the wireless base station apparatus. A DC subcarrier is arranged at the center frequency, thereby forming a transmission signal band of 18.015 MHz (the number of subcarriers=1201). Note that the DC subcarrier is not transmitted.

The difference between the channel bandwidth of 20 MHz and the transmission signal band of 18.015 MHz, i.e., 1.985 MHz (0.9925 MHz on each side) serves as a guard band. About 5% of the 20-MHz channel bandwidth is applied on each side. The guard band is not used to transmit signals considering the design of element components such as transmission and reception filters that are hard to obtain ideal characteristics. Note that the system description may regard the transmission bandwidth as 18 MHz and the guard bandwidth as 2 MHz (1 MHz on each side) excluding the DC subcarrier. The transmission signal is divided into RBs (resource blocks) each including 12 subcarriers. The mobile wireless terminal apparatus A is assigned one or more RBs to receive PDSCH within the 20-MHz channel bandwidth. The structure of an RB is the same as in FIG. 4.

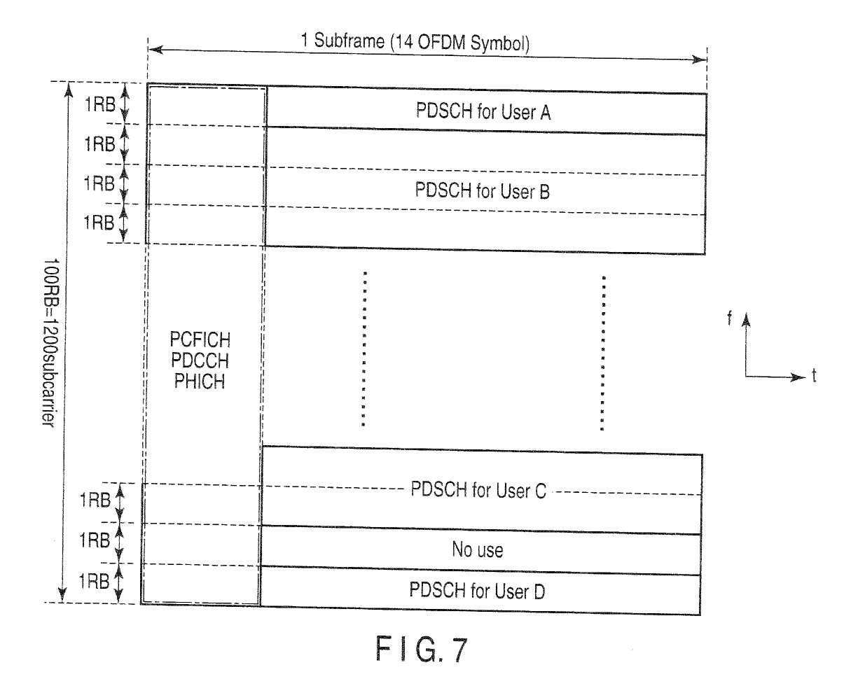

FIG. 7 shows an example of the structure of the transmission signal of one subframe. The RBs are arranged in the frequency direction. The transmission signal includes control signals (PCFICH, PDCCH, and PHICH) to transmit control information and information signals (PDSCH) to transmit transmission information. PDSCH in each RB transmits information for a mobile wireless terminal apparatus.

Hence, each mobile wireless terminal apparatus needs to receive only an RB that forms PDSCH for itself. PDCCHs are multiplexed and arranged throughout the signal band. Each PDCCH contains information representing PDSCH assignment to a specific mobile wireless terminal apparatus.

Since the PDCCH arrangement is not fixed, each mobile wireless terminal apparatus must search for a PDCCH addressed to itself. It is therefore necessary to receive the whole signal band, i.e., the transmission signal of the 20-MHz channel bandwidth. FIG. 7 does not illustrate the DC subcarrier which transmits no signal and is therefore insignificant from the viewpoint of transmission of control information and transmission information.

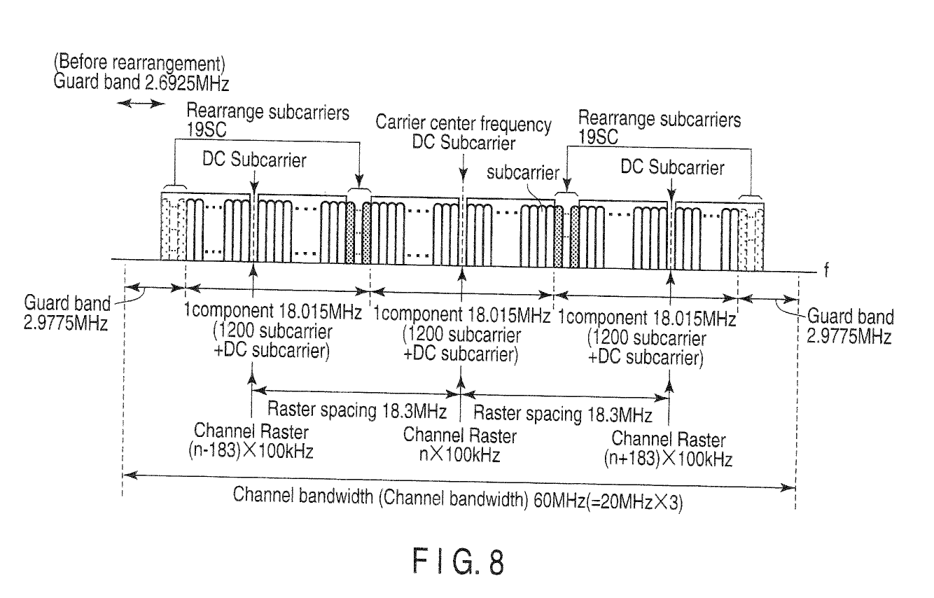

The mobile wireless terminal apparatus B can receive a channel bandwidth of 60 MHz as shown in FIG. 8. The wireless base station apparatus transmits a channel bandwidth of 60 MHz, as shown in FIG. 8. More specifically, the wireless base station apparatus continuously arranges, in the frequency direction, three components each corresponding to a transmission signal having a channel bandwidth of 20 MHz, thereby forming a channel bandwidth of 60 MHz in total. To the mobile wireless terminal apparatus A, a control unit 200 and a physical resource assigning unit 204 assign one of the three continuously arranged channel bands as the reception range.

Of the three 20-MHz channel bands, the channel band at each end arranges the DC subcarrier at its center at a position spaced apart from the DC subcarrier of the middle channel band by 18.015 MHz or more at a spacing that makes the 100-kHz channel raster match the 15-kHz subcarrier spacing.

Since the least common multiple of the 100-kHz channel raster and the 15-kHz subcarrier spacing is 300 kHz, the selectable channel raster is 300 kHz. The minimum DC subcarrier spacing without signal overlap is 18.3 MHz. Hence, the DC subcarriers of the channel bands at both ends are located at positions spaced apart from the DC subcarrier (carrier center frequency) of the middle 20-MHz channel band by 18.3 MHz to the upper and lower sides.

When the carrier center frequency is n×100 kHz, the DC subcarrier used to receive the transmission signal of the 20-MHz channel band on the lower side is arranged at (n−183)×100 kHz. On the other hand, the DC subcarrier used to receive the transmission signal of the 20-MHz channel band on the upper side is arranged at (n+183)×100 kHz.

At this time, the 20-MHz channel bands adjacent to each other have a gap between them because the transmission band is 18.015 MHz. As for the transmission signal of the channel band at each end, the outer subcarriers are rearranged on the side of the middle channel band. Nineteen subcarriers are rearranged in each channel band. This rearrangement is equivalent to moving 19 subcarriers except the DC subcarriers toward the carrier center frequency.

The transmission signal of the channel band at each end which has undergone the rearrangement becomes asymmetrical with respect to its DC subcarrier. The subcarrier rearrangement makes the guard bandwidth 2.9775 MHz. Hence, the transmission signal having the channel bandwidth of 60 MHz can ensure a guard band of a little less than 5%.

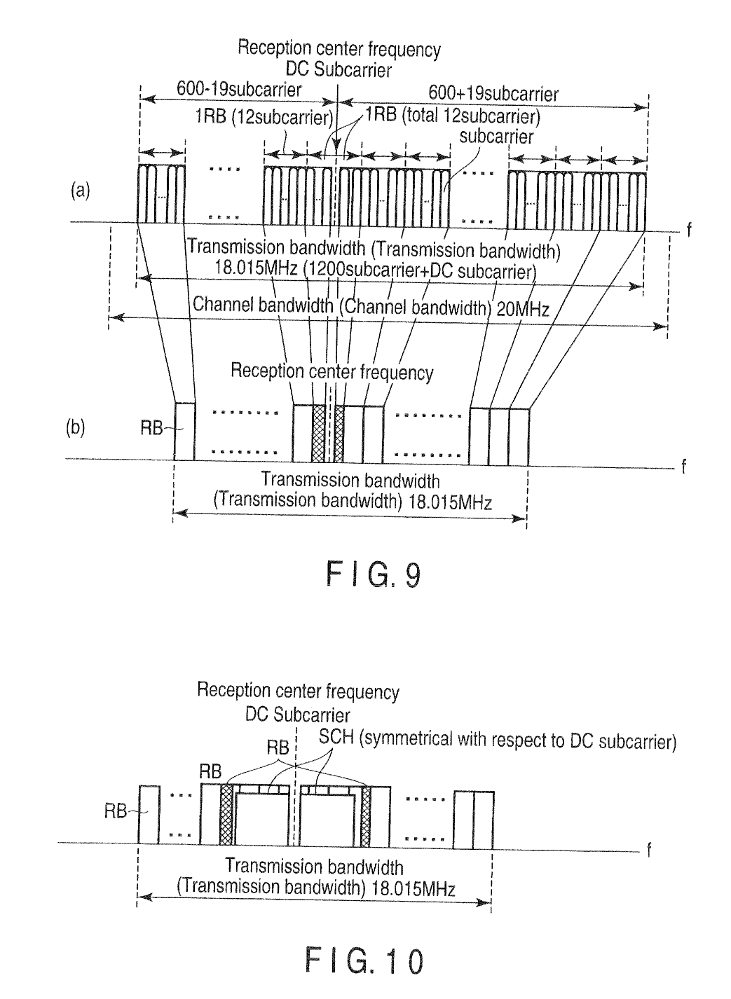

FIG. 9 shows a state in which in the above-described subcarrier arrangement, the channel bands the control unit 200 and the physical resource assigning unit 204 have assigned to the mobile wireless terminal apparatuses are divided into resource blocks. Even when the subcarriers are put together into resource blocks, the total number of subcarriers does not change. As indicated by (a) of FIG. 9, the 60-MHz channel band is divided, from its two ends, into resource blocks each including 12 subcarriers. In the channel band at each end, the DC subcarrier is arranged in one resource block, as indicated by (b) of FIG. 9. Resource blocks are arranged on both sides of the DC subcarrier. That is, two hatched portions are handled as one resource block.

On occasion, search channels (SCHs) necessary for initial synchronization are arranged. In the OFDM system, the SCHs are preferably received in the time domain and therefore arranged symmetrically with respect to the DC subcarrier on the frequency axis of the same time. FIG. 10 shows an example of the arrangement of SCHs and resource blocks after subcarrier rearrangement. That is, the control unit 200 and the physical resource assigning unit 204 arrange the SCHs symmetrically with respect to the DC subcarrier. Resource blocks are arranged on both sides of the SCH region. Broadcast channels to be received next to the SCHs may be arranged in the same manner. FIG. 10 illustrates the SCHs and the resource blocks which overlap on the same frequency axis. However, when the SCHs are transmitted, no resource blocks are transmitted at that frequency. In FIG. 10, two hatched portions are handled as one resource block.

In the transmission signal described above, the subcarrier rearrangement is done by moving the subcarriers toward the carrier center frequency. Hence, the mobile wireless terminal apparatus B can easily be implemented by changing the control of a control unit 100 and a frequency channel separation unit 111.

A fast Fourier transform unit 110 divides the subcarriers including those rearranged in the above-described way into subcarrier signals. The frequency channel separation unit 111 separates the divided subcarrier signals into a reference signal, control channel signals, and data signals in accordance with an instruction from the control unit 100. The mobile wireless terminal apparatus thus receives the assigned subcarriers including the rearranged subcarriers.

The mobile wireless terminal apparatus A whose maximum receivable channel bandwidth is 20 MHz receives an assigned one of the three continuously arranged 20-MHz channel bands by defining its DC subcarrier as the reception center frequency. If the channel band at the center is assigned, the operation is the same as in normally receiving a signal of a 20-MHz reception bandwidth.

If the upper or lower 20-MHz channel band is assigned, the transmission signal is asymmetrical with respect to the DC subcarrier of the band. When the number of necessary points (subcarriers) is 1,201, the fast Fourier transform unit 110 performs time-frequency conversion using FFT at 2,048 points. Hence, the asymmetry of the order of 19 subcarriers has no influence.

When the reception filter characteristic of a reception RF unit 109 is designed equally for the reception band, the reception filter characteristic before the FFT needs to widen by 19 subcarriers. In this example, however, the guard bandwidth is 2.9775 MHz, which is normally 0.9925 MHz in the 20-MHz channel bandwidth. It is therefore easy to increase the reception filter bandwidth by 19 subcarriers, i.e., 0.285 MHz in actual design. The transmission signal of the center band is receivable even by a receiver capable of receiving only a symmetrical signal of a 20-MHz channel band.

As described above, in the wireless base station apparatus and the mobile wireless terminal apparatuses A and B having the above arrangements, the channel band at each end of the three 20-MHz channel bands has the DC subcarrier arranged at a position spaced apart from the DC subcarrier of the middle channel band by 18.015 MHz or more and, more specifically, by 18.3 MHz corresponding to a spacing of 300 kHz that is the least common multiple of the 100-kHz channel raster and the 15-kHz subcarrier spacing in the downlink. The subcarriers at the two ends are rearranged between the channel bands. This enables communication using the three adjacent channel bands.

According to the wireless base station apparatus and the mobile wireless terminal apparatuses A and B having the above arrangements, it is possible to prevent any degradation in the reception characteristic of the mobile wireless terminal apparatus A which has the narrow reception channel bandwidth of 20 MHz. Additionally, the mobile wireless terminal apparatus B for receiving a wide bandwidth of 60 MHz can effectively utilize the 60-MHz bandwidth and also implement a change in reception control by only a small modification.

In Example 2, the transmission signal of the channel band at the center and the transmission signals of the channel bands on both sides have the same bandwidth of 18.015 MHz (the number of subcarriers=1201). However, they need not always be the same.

In Example 2, three channel bands are bundled. Instead, two channel bands, i.e., the middle channel band and the channel band on the upper or lower side may be bundled. Four or more channel bands may be bundled. Continuing five channel bands will be described in Example 3.

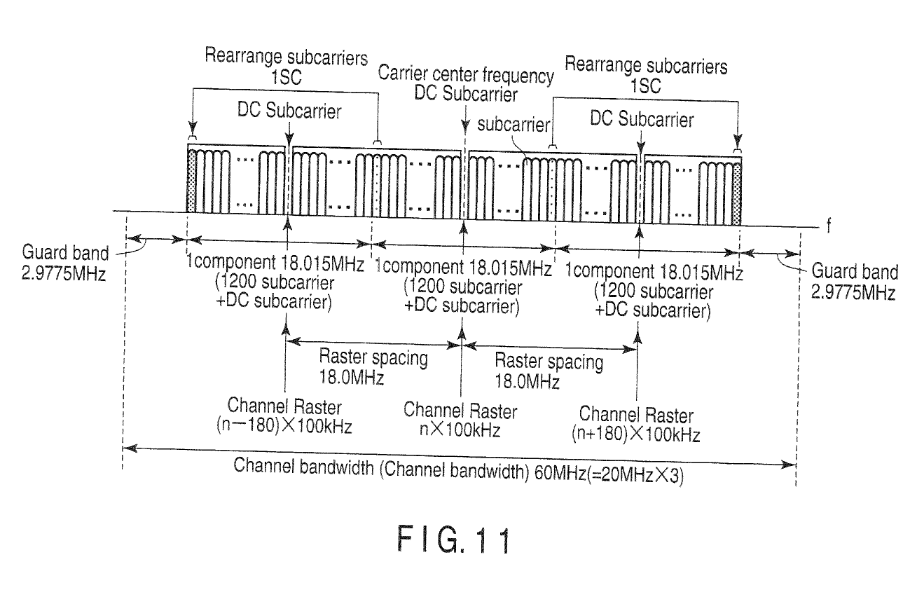

In Example 2, the subcarrier rearrangement is done as in FIG. 8. However, as shown in FIG. 11, the subcarriers of the channel band at each end may overlap those of the middle channel band. The overlapping subcarriers are rearranged at the ends.

In the example shown in FIG. 11 as well, the control unit 200 and the physical resource assigning unit 204 arrange three transmission signals each having a channel bandwidth of 20 MHz continuously in the frequency direction. The wireless base station apparatus transmits a channel bandwidth of 60 MHz. The mobile wireless terminal apparatus B receives the 60-MHz band. To the mobile wireless terminal apparatus A, the control unit 200 and the physical resource assigning unit 204 assign one of the three continuously arranged 20-MHz channel bands as the reception range.

The channel bands are arranged at a spacing that makes the 100-kHz channel raster match the 15-kHz subcarrier spacing. Since the least common multiple of the 100-kHz channel raster and the 15-kHz subcarrier spacing is 300 kHz, the selectable channel raster is 300 kHz. Permitting minimum signal overlap, the DC subcarrier spacing is 18.0 MHz.

When the carrier center frequency is n×100 kHz, the DC subcarrier used to receive the transmission signal of the 20-MHz channel band adjacent on the lower side is arranged at (n−180)×100 kHz. On the other hand, the DC subcarrier used to receive the transmission signal of the 20-MHz channel band adjacent on the upper side is arranged at (n+180)×100 kHz.

At this time, the subcarriers overlap between the 20-MHz channel bands. The overlapping subcarriers are rearranged outside the 20-MHz channel bands on both sides in a direction to separate from the carrier center frequency. When the DC subcarrier spacing is 18.0 MHz, only one subcarrier needs to be rearranged. This rearrangement is equivalent to moving one subcarrier except the DC subcarriers an the direction to separate from the carrier center frequency (transmitting side).

The transmission signal of the channel band which has undergone the rearrangement becomes asymmetrical with respect to its DC subcarrier. As described concerning the rearrangement shown in FIG. 8, to rearrange only one subcarrier, no special change in the hardware configuration is necessary. This can easily be implemented by changing the control of the control unit 200, the physical resource assigning unit 204, the control unit 100, and the frequency channel separation unit 111.

The subcarrier rearrangement makes the guard bandwidth 2.9775 MHz. Hence, the transmission signal having the channel bandwidth of 60 MHz can ensure a guard band of a little less than 5%.

In FIG. 11, the transmission signal of the channel band at the center and the transmission signals of the channel bands on both sides have the same bandwidth of 18.015 MHz (the number of subcarriers=1201). However, they need not always be the same. A case in which the transmission bandwidth is narrower in the channel bands on both sides will be explained in Example 4.

In FIG. 11, three channel bands are bundled. Instead, two channel bands, i.e., the middle channel band and the channel band on the upper or lower side may be bundled. This will be explained in Example 5. Four or more channel bands may be bundled. Continuing five channel bands will be described in a modification of Example 3.

### Example 3

In Example 3, an OFDM cellular system will be exemplified which operates, in a single 100-MHz frequency band, a mobile wireless terminal apparatus A capable of receiving a maximum channel bandwidth of 20 MHz and a mobile wireless terminal apparatus B capable of receiving a channel bandwidth of 100 MHz.

The mobile wireless terminal apparatus A can receive a channel band as shown in FIG. 6. More specifically, 1,200 subcarriers at a subcarrier spacing of 15 kHz are arranged in one transmission signal having a channel bandwidth of 20 MHz transmitted from the wireless base station apparatus. A DC subcarrier is arranged at the center frequency, thereby forming a transmission signal band of 18.015 MHz (the number of subcarriers=1201). Note that the DC subcarrier is not transmitted.

The difference between the channel bandwidth of 20 MHz and the transmission signal band of 18.015 MHz, i.e., 1.985 MHz (0.9925 MHz on each side) serves as a guard band. About 5% of the 20-MHz channel bandwidth is applied on each side. The guard band is not used to transmit signals considering the design of element components such as transmission and reception filters that are hard to obtain ideal characteristics. Note that the system description may regard the transmission bandwidth as 18 MHz and the guard bandwidth as 2 MHz (1 MHz on each side) excluding the DC subcarrier. The transmission signal is divided into RBs (resource blocks) each including 12 subcarriers. The mobile wireless terminal apparatus A is assigned one or more RBs to receive PDSCH within the 20-MHz channel bandwidth. The structure of an RB is the same as in FIG. 4.

FIG. 7 shows an example of the structure of the transmission signal of one subframe. The RBs are arranged in the frequency direction. The transmission signal includes control signals (PCFICH, PDCCH, and PHICH) to transmit control information and information signals (PDSCH) to transmit transmission information. PDSCH in each RB transmits information for a mobile wireless terminal apparatus.

Hence, each mobile wireless terminal apparatus needs to receive only an RB that forms PDSCH for itself. PDCCHs are multiplexed and arranged throughout the signal band. Each PDCCH contains information representing PDSCH assignment to a specific mobile wireless terminal apparatus.

Since the PDCCH arrangement is not fixed, each mobile wireless terminal apparatus must search for a PDCCH addressed to itself. It is therefore necessary to receive the whole signal band, i.e., the transmission signal of the 20-MHz channel bandwidth. FIG. 7 does not illustrate the DC subcarrier which transmits no signal and is therefore insignificant from the viewpoint of transmission of control information and transmission information.

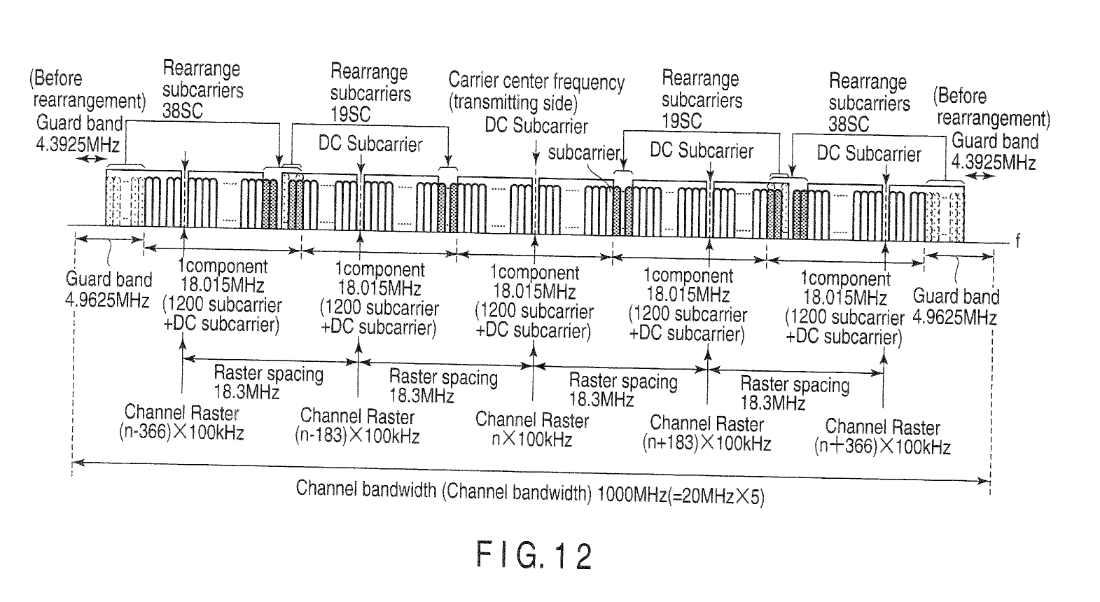

The mobile wireless terminal apparatus B can receive a channel bandwidth of 100 MHz as shown in FIG. 12. The wireless base station apparatus transmits a channel bandwidth of 100 MHz, as shown in FIG. 12. More specifically, the wireless base station apparatus continuously arranges, in the frequency direction, five components each corresponding to a transmission signal having a channel bandwidth of 20 MHz, thereby forming a channel bandwidth of 100 MHz in total. To the mobile wireless terminal apparatus A, a control unit 200 and a physical resource assigning unit 204 assign one of the five continuously arranged channel bands as the reception range.

Of the five 20-MHz channel bands, each of the two channel bands adjacent to the middle channel band arranges the DC subcarrier at its center at a position spaced apart from the DC subcarrier of the middle channel band by 18.015 MHz or more at a spacing that makes the 100-kHz channel raster match the 15-kHz subcarrier spacing.

Since the least common multiple of the 100-kHz channel raster and the 15-kHz subcarrier spacing is 300 kHz, the selectable channel raster is 300 kHz. The minimum DC subcarrier spacing without signal overlap is 18.3 MHz. Hence, the DC subcarriers of the two adjacent channel bands are located at positions spaced apart from the DC subcarrier (carrier center frequency) of the middle 20-MHz channel band by 18.3 MHz to the upper and lower sides.

When the carrier center frequency is n×1.00 kHz, the DC subcarrier used to receive the transmission signal of the 20-MHz channel band adjacent on the lower side is arranged at (n−183)×100 kHz. On the other hand, the DC subcarrier used to receive the transmission signal of the 20-MHz channel band adjacent on the upper side is arranged at (n+183)×100 kHz.

At this time, the 20-MHz channel bands adjacent to each other have a gap between them because the transmission band is 18.015 MHz. As for the transmission signal of each channel band adjacent to the middle channel band, the outer subcarriers are rearranged on the side of the middle channel band. Nineteen subcarriers are rearranged in each channel band. This rearrangement is equivalent to moving 19 subcarriers except the DC subcarriers toward the carrier center frequency.

In the five 20-MHz channel bands, the DC subcarriers of the two channel bands at both ends are also located at positions spaced apart from the DC subcarriers of the adjacent channel bands by 18.3 MHz.

When the carrier center frequency is n×100 kHz, the DC subcarrier used to receive the transmission signal of the channel band at the lower end is arranged at (n−366)×100 kHz. On the other hand, the DC subcarrier used to receive the transmission signal of the channel band at the upper end is arranged at (n+366)×100 kHz when the carrier center frequency is n×100 kHz.

At this time, the 20-MHz channel bands adjacent to each other have a gap between them because the transmission band is 18.015 MHz. Additionally, the outer 19 subcarriers of each channel band adjacent to the middle channel band are rearranged inside. As for the transmission signal of the channel band at each end, the outer 38 subcarriers are rearranged on the side of the middle channel band. This rearrangement is equivalent to moving 38 subcarriers except the DC subcarriers toward the carrier center frequency.

The transmission signal of each channel band except the middle channel band, which has undergone the rearrangement, becomes asymmetrical with respect to its DC subcarrier. The subcarrier rearrangement makes the guard bandwidth 4.9625 MHz. Hence, the transmission signal having the channel bandwidth of 100 MHz can ensure a guard band of a little less than 5%.

As described in Example 2 with reference to FIG. 9, even when the subcarriers are divided into resource blocks, the total number of subcarriers does not change. Hence, the 100-MHz channel band is divided, from its two ends, into resource blocks each including 12 subcarriers. In each channel band except the middle channel band, the DC subcarrier is arranged in one resource block. Resource blocks are arranged on both sides of the DC subcarrier.

On occasion, search channels (SCHs) necessary for initial synchronization are arranged. In the OFDM system, the SCHs are preferably received in the time domain and therefore arranged based on the DC subcarrier. FIG. 10 shows an example of the arrangement of SCHs and resource blocks after subcarrier rearrangement. The SCHs are arranged symmetrically with respect to the DC subcarrier. Resource blocks are arranged on both sides of the SCH region. Broadcast channels to be received next to the SCHs may be arranged in the same manner.

In such a transmission signal, the subcarrier rearrangement is done by moving the subcarriers toward the carrier center frequency. Hence, the mobile wireless terminal apparatus B can easily be implemented by changing the control of a control unit 100 and a frequency channel separation unit 111.

A fast Fourier transform unit 110 divides the subcarriers including those rearranged in the above-described way into subcarrier signals. The frequency channel separation unit 111 separates the divided subcarrier signals into a reference signal, control channel signals, and data signals in accordance with an instruction from the control unit 100. The mobile wireless terminal apparatus thus receives the assigned subcarriers including the rearranged subcarriers.

The mobile wireless terminal apparatus A whose maximum receivable channel bandwidth is 20 MHz receives an assigned one of the five continuously arranged 20-MHz channel bands by defining its DC subcarrier as the reception center frequency. If the channel band at the center is assigned, the operation is the same as in normally receiving a signal of a 20-MHz reception bandwidth.

If a channel band except the middle 20-MHz channel band is assigned, the transmission signal is asymmetrical with respect to the DC subcarrier of the band. When the number of necessary points (subcarriers) is 1,201, the fast Fourier transform unit 110 performs time-frequency conversion using FFT at 2,048 points. Hence, the asymmetry of the order of 19 to 38 subcarriers has no influence.

When the reception filter characteristic of a reception RF unit 109 is designed equally for the reception band, the reception filter characteristic before the FFT needs to widen by 19 subcarriers. In this example, however, the guard bandwidth is 2.9775 MHz, which is normally 0.9925 MHz in the 20-MHz channel bandwidth. It is therefore easy to increase the reception filter bandwidth by 19 subcarriers, i.e., 0.285 MHz in actual design. The transmission signal of the center band is receivable even by a receiver capable of receiving only a symmetrical signal of a 20-MHz channel band.

As described above, in the wireless base station apparatus and the mobile wireless terminal apparatuses A and B having the above arrangements, each channel band adjacent to the middle channel band of the five 20-MHz channel bands has the DC subcarrier arranged at a position spaced apart from the DC subcarrier of the middle channel band by 18.015 MHz or more and, more specifically, by 18.3 MHz corresponding to a spacing of 300 kHz that is the least common multiple of the 100-kHz channel raster and the 15-kHz subcarrier spacing in the downlink. The outer subcarriers are rearranged on the side of the middle channel band. In the channel band at each end as well, the DC subcarrier is arranged in the same way, and the outer 38 subcarriers are rearranged on the side of the inner channel band. This rearrangement enables communication using the five adjacent channel bands.

According to the wireless base station apparatus and the mobile wireless terminal apparatuses A and B having the above arrangements, it is possible to prevent any degradation in the reception characteristic of the mobile wireless terminal apparatus A which has the narrow reception channel bandwidth of 20 MHz. Additionally, the mobile wireless terminal apparatus B for receiving a wide bandwidth of 100 MHz can effectively utilize the 100-MHz bandwidth and also implement a change in reception control by only a small modification.

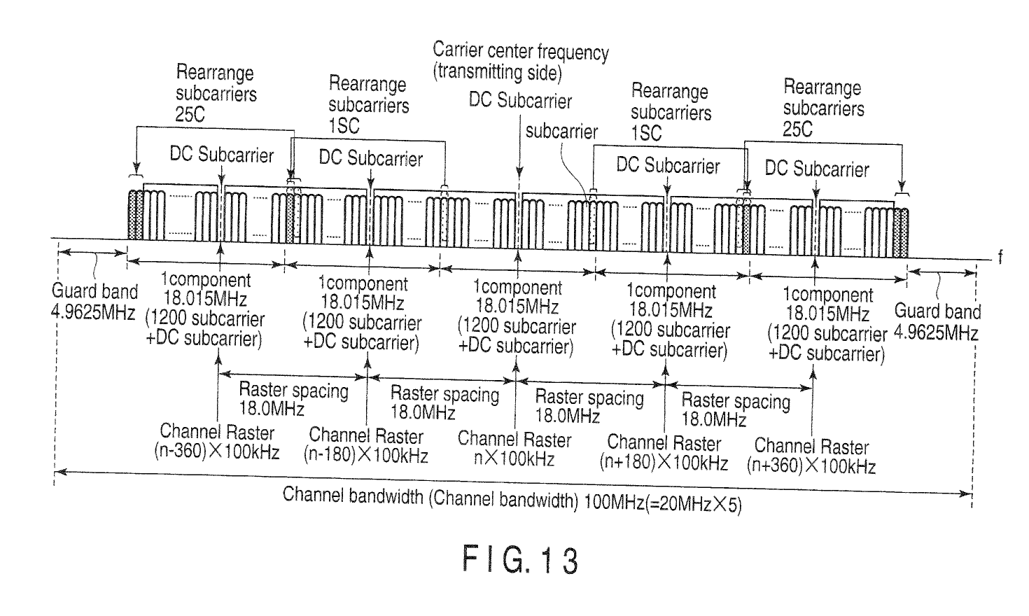

In the above-described example, the subcarrier rearrangement is done as in FIG. 12. However, as shown in FIG. 13, the subcarriers of each channel band adjacent to the middle channel band may overlap those of the middle channel band. The overlapping subcarriers are rearranged at the ends. Additionally, the subcarriers of the channel band at each end may overlap those of the adjacent channel band. The overlapping subcarriers are rearranged at the ends.

In the example shown in FIG. 13 as well, the control unit 200 and the physical resource assigning unit 204 arrange five transmission signals each having a channel bandwidth of 20 MHz continuously in the frequency direction. The wireless base station apparatus transmits a channel bandwidth of 100 MHz. The mobile wireless terminal apparatus B receives the 100-MHz band. To the mobile wireless terminal apparatus A, the control unit 200 and the physical resource assigning unit 204 assign one of the five continuously arranged 20-MHz channel bands as the reception range.

The channel bands are arranged at a spacing that makes the 100-kHz channel raster match the 15-kHz subcarrier spacing. Since the least common multiple of the 100-kHz channel raster and the 15-kHz subcarrier spacing is 300 kHz, the selectable channel raster is 300 kHz. Permitting minimum signal overlap, the DC subcarrier spacing is 18.0 MHz.

When the carrier center frequency is n×100 kHz, the DC subcarriers used to receive the transmission signals of the two channel bands adjacent on the lower side of the middle channel band are arranged at (n−180)×100 kHz and (n−360)×100 kHz, respectively. On the other hand, the DC subcarriers used to receive the transmission signals of the two channel bands adjacent on the upper side are arranged at (n+180)×100 kHz and (n+360)×100 kHz, respectively.

At this time, the subcarriers overlap between the 20-MHz channel bands. The overlapping subcarriers are rearranged outside the 20-MHz channel bands on both sides in a direction to separate from the carrier center frequency. When the DC subcarrier spacing is 18.0 MHz, only one subcarrier needs to be rearranged outside in each channel band adjacent to the middle channel band. This rearrangement is equivalent to moving one subcarrier except the DC subcarriers in the direction to separate from the carrier center frequency (transmitting side). In the adjacent channel band at each end, only two subcarriers need to be rearranged outside. This rearrangement is equivalent to moving two subcarriers except the DC subcarriers in the direction to separate from the carrier center frequency (transmitting side).

The transmission signal of the channel band which has undergone the rearrangement becomes asymmetrical with respect to its DC subcarrier. As described concerning the rearrangement shown in FIG. 12, to rearrange only one subcarrier, no special change in the hardware configuration is necessary. This can easily be implemented by changing the control of the control unit 200, the physical resource assigning unit 204, the control unit 100, and the frequency channel separation unit 111.

The subcarrier rearrangement also makes the guard bandwidth 4.9625 MHz. Hence, the transmission signal having the channel bandwidth of 100 MHz can ensure a guard band of a little less than 5%.

### Example 4

In Example 4, an OFDM cellular system will be exemplified which operates, in a single 40-MHz frequency band, a mobile wireless terminal apparatus A capable of receiving a maximum channel bandwidth of 20 MHz and a mobile wireless terminal apparatus B capable of receiving a channel bandwidth of 40 MHz.

The mobile wireless terminal apparatus A can receive a channel band as shown in FIG. 6. More specifically, 1,200 subcarriers at a subcarrier spacing of 15 kHz are arranged in one transmission signal having a channel bandwidth of 20 MHz transmitted from the wireless base station apparatus. A DC subcarrier is arranged at the center frequency, thereby forming a transmission signal band of 18.015 MHz (the number of subcarriers=1201). Note that the DC subcarrier is not transmitted.

The difference between the channel bandwidth of 20 MHz and the transmission signal band of 18.015 MHz, i.e., 1.985 MHz (0.9925 MHz on each side) serves as a guard band. About 5% of the 20-MHz channel bandwidth is applied on each side. The guard band is not used to transmit signals considering the design of element components such as transmission and reception filters that are hard to obtain ideal characteristics. Note that the system description may regard the transmission bandwidth as 18 MHz and the guard bandwidth as 2 MHz (1 MHz on each side) excluding the DC subcarrier. The transmission signal is divided into RBs (resource blocks) each including 12 subcarriers. The mobile wireless terminal apparatus A is assigned one or more RBs to receive PDSCH within the 20-MHz channel bandwidth. The structure of an RB is the same as in FIG. 4.

FIG. 7 shows an example of the structure of the transmission signal of one subframe. The RBs are arranged in the frequency direction. The transmission signal includes control signals (PCFICH, PDCCH, and PHICH) to transmit control information and information signals (PDSCH) to transmit transmission information. PDSCH in each RB transmits information for a mobile wireless terminal apparatus.

Hence, each mobile wireless terminal apparatus needs to receive only an RB that forms PDSCH for itself. PDCCHs are multiplexed and arranged throughout the signal band. Each PDCCH contains information representing PDSCH assignment to a specific mobile wireless terminal apparatus.

Since the PDCCH arrangement is not fixed, each mobile wireless terminal apparatus must search for a PDCCH addressed to itself. It is therefore necessary to receive the whole signal band, i.e., the transmission signal of the 20-MHz channel bandwidth. FIG. 7 does not illustrate the DC subcarrier which transmits no signal and is therefore insignificant from the viewpoint of transmission of control information and transmission information.

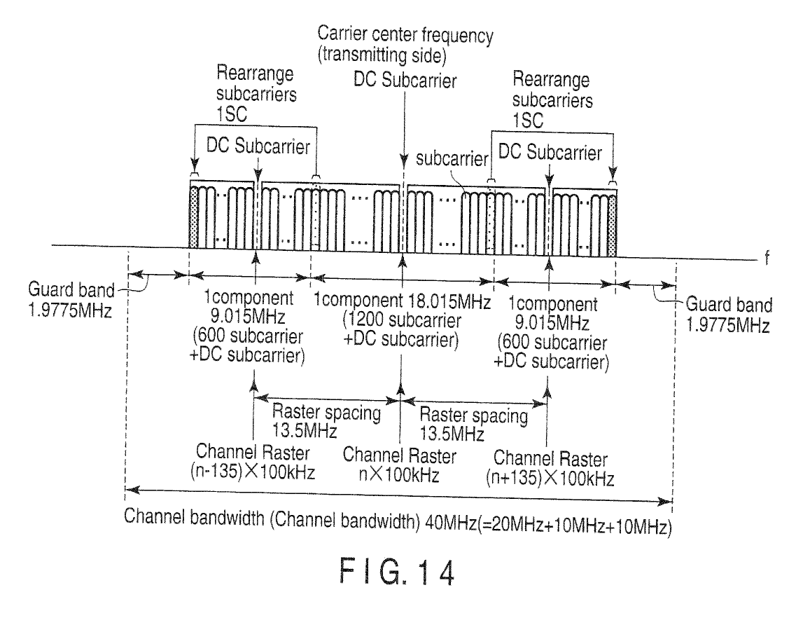

The mobile wireless terminal apparatus B can receive a channel bandwidth of 40 MHz as shown in FIG. 14. The wireless base station apparatus transmits a channel bandwidth of 40 MHz, as shown in FIG. 14. More specifically, the wireless base station apparatus arranges a transmission signal of a 20-MHz channel bandwidth as one component and, on each side of the signal, a transmission signal of a 10-MHz channel bandwidth as one component, thereby forming a channel bandwidth of 40 MHz in total. To the mobile wireless terminal apparatus A, a control unit 200 and a physical resource assigning unit 204 assign the channel band (20 MHz) having a DC subcarrier at the carrier center frequency as the reception range.

Of the three channel bands, the 10-MHz channel band at each end arranges the DC subcarrier at its center at a position spaced apart from the DC subcarrier of the middle channel band (20 MHz) by 13.515 MHz or more at a spacing that makes the 100-kHz channel raster match the 15-kHz subcarrier spacing.

Since the least common multiple of the 100-kHz channel raster and the 15-kHz subcarrier spacing is 300 kHz, the selectable channel raster is 300 kHz. Permitting minimum signal overlap, the DC subcarrier spacing is 13.5 MHz. Hence, the DC subcarriers of the channel bands at both ends are located at positions spaced apart from the DC subcarrier (carrier center frequency) of the middle 20-MHz channel band by 13.5 MHz to the upper and lower sides.

When the carrier center frequency is n×100 kHz, the DC subcarrier used to receive the transmission signal of the 10-MHz channel band on the lower side is arranged at (n−135)×100 kHz. On the other hand, the DC subcarrier used to receive the transmission signal of the 10-MHz channel band on the upper side is arranged at (n+135)×100 kHz.

At this time, each 10-MHz channel band and the middle channel band have a gap between them because the transmission band is 9.015 MHz (the number of subcarriers=601). As for the transmission signal of the channel band at each end, subcarriers which overlap those of the middle channel band are rearranged outside each channel band. One subcarrier is rearranged in each channel band. This rearrangement is equivalent to moving one subcarrier except the DC subcarriers toward the carrier center frequency.

The transmission signal of the channel band at each end which has undergone the rearrangement becomes asymmetrical with respect to its DC subcarrier. The subcarrier rearrangement makes the guard bandwidth 1.9775 MHz. Hence, the transmission signal having the channel bandwidth of 40 MHz can ensure a guard band of a little less than 5%.

In such a transmission signal, the subcarrier rearrangement is done by moving the subcarriers outward from the carrier center frequency. Since the number of moved subcarriers is only one, the mobile wireless terminal apparatus B can easily be implemented by changing the control of a control unit 100 and a frequency channel separation unit 111.

A fast Fourier transform unit 110 divides the subcarriers including those rearranged in the above-described way into subcarrier signals. The frequency channel separation unit 111 separates the divided subcarrier signals into a reference signal, control channel signals, and data signals in accordance with an instruction from the control unit 100. The mobile wireless terminal apparatus thus receives the assigned subcarriers including the rearranged subcarriers.

The mobile wireless terminal apparatus A whose maximum receivable channel bandwidth is 20 MHz receives the 20-MHz channel band of the three continuously arranged 10-, 20- and 10-MHz channel bands by defining its DC subcarrier as the reception center frequency. That is, the operation is the same as in normally receiving a signal of a 20-MHz reception bandwidth.

As described above, in the wireless base station apparatus and the mobile wireless terminal apparatuses A and B having the above arrangements, the channel band at each end of the 10-, 20- and 10-MHz channel bands has the DC subcarrier arranged at a position spaced apart from the DC subcarrier of the middle channel band by 13.515 MHz or more and, more specifically, by 13.5 MHz corresponding to a spacing of 300 kHz that is the least common multiple of the 100-kHz channel raster and the 15-kHz subcarrier spacing in the downlink. The overlapping subcarriers are rearranged outside each channel band. This enables communication using the three adjacent channel bands.

According to the wireless base station apparatus and the mobile wireless terminal apparatuses A and B having the above arrangements, it is possible to prevent any degradation in the reception characteristic of the mobile wireless terminal apparatus A which has the narrow reception channel bandwidth of 20 MHz. Additionally, the mobile wireless terminal apparatus B for receiving a wide bandwidth of 40 MHz can effectively utilize the 40-MHz bandwidth and also implement a change in reception control by only a small modification.

The 10-MHz channel band can also be assigned to a mobile wireless terminal apparatus that requires a 10-MHz channel band. This enables to make different terminal capabilities exist in one system and also increase the frequency band utilization efficiency.

The 10-MHz bands on both sides are received by the mobile wireless terminal apparatus B capable of receiving the 40-MHz band. For this reason, integrating the 10-MHz bands on both sides in the operation makes it possible to handle them as a 20-MHz band in terms of control.

### Example 5

In Example 5, an OFDM cellular system will be exemplified which operates, in a single 40-MHz frequency band, a mobile wireless terminal apparatus A capable of receiving a maximum channel bandwidth of 20 MHz and a mobile wireless terminal apparatus B capable of receiving a channel bandwidth of 40 MHz.

The mobile wireless terminal apparatus A can receive a channel band as shown in FIG. 6. More specifically, 1,200 subcarriers at a subcarrier spacing of 15 kHz are arranged in one transmission signal having a channel bandwidth of 20 MHz transmitted from the wireless base station apparatus. A DC subcarrier is arranged at the center frequency, thereby forming a transmission signal band of 18.015 MHz (the number of subcarriers=1201). Note that the DC subcarrier is not transmitted.

The difference between the channel bandwidth of 20 MHz and the transmission signal band of 18.015 MHz, i.e., 1.985 MHz (0.9925 MHz on each side) serves as a guard band. About 5% of the 20-MHz channel bandwidth is applied on each side. The guard band is not used to transmit signals considering the design of element components such as transmission and reception filters that are hard to obtain ideal characteristics. Note that the system description may regard the transmission bandwidth as 18 MHz and the guard bandwidth as 2 MHz (1 MHz on each side) excluding the DC subcarrier. The transmission signal is divided into RBs (resource blocks) each including 12 subcarriers. The mobile wireless terminal apparatus A is assigned one or more RBs to receive PDSCH within the 20-MHz channel bandwidth. The structure of an RB is the same as in FIG. 4.

FIG. 7 shows an example of the structure of the transmission signal of one subframe. The RBs are arranged in the frequency direction. The transmission signal includes control signals (PCFICH, PDCCH, and PHICH) to transmit control information and information signals (PDSCH) to transmit transmission information. PDSCH in each RB transmits information for a mobile wireless terminal apparatus.

Hence, each mobile wireless terminal apparatus needs to receive only an RB that forms PDSCH for itself. PDCCHs are multiplexed and arranged throughout the signal band. Each PDCCH contains information representing PDSCH assignment to a specific mobile wireless terminal apparatus.

Since the PDCCH arrangement is not fixed, each mobile wireless terminal apparatus must search for a PDCCH addressed to itself. It is therefore necessary to receive the whole signal band, i.e., the transmission signal of the 20-MHz channel bandwidth. FIG. 7 does not illustrate the DC subcarrier which transmits no signal and is therefore insignificant from the viewpoint of transmission of control information and transmission information.

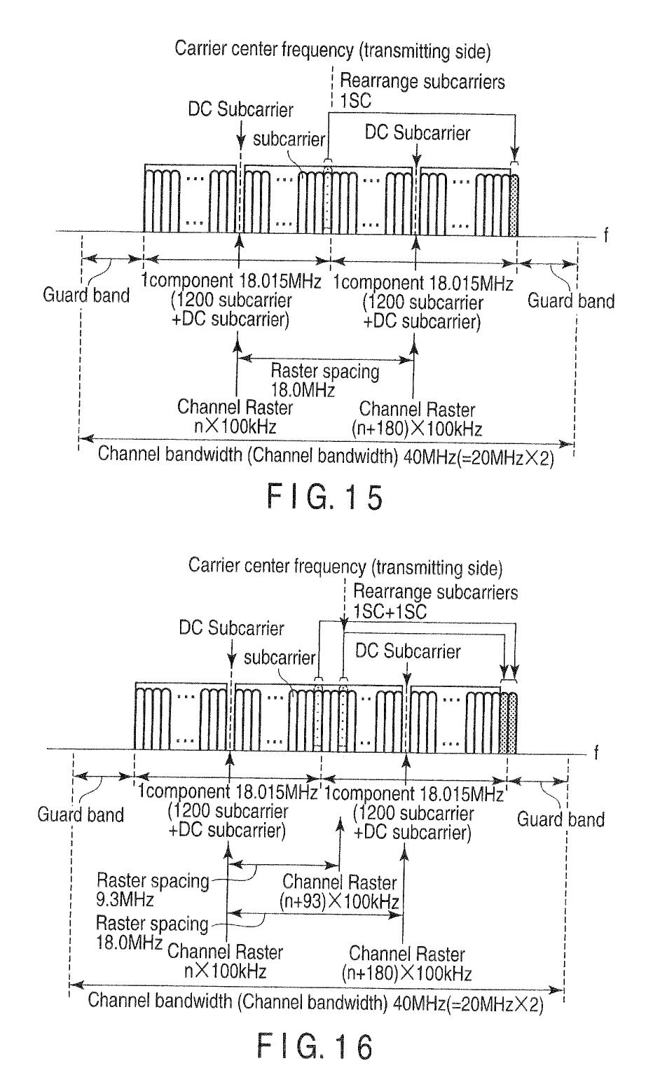

The mobile wireless terminal apparatus B can receive a channel bandwidth of 40 MHz as shown in FIG. 15. The wireless base station apparatus transmits a channel bandwidth of 40 MHz, as shown in FIG. 15. More specifically, the wireless base station apparatus continuously arranges, in the frequency direction, two components each corresponding to a transmission signal having a channel bandwidth of 20 MHz, thereby forming a channel bandwidth of 40 MHz in total. To the mobile wireless terminal apparatus A, a control unit 200 and a physical resource assigning unit 204 assign one of the two transmission signals of the 20-MHz channel band as the reception range.

The DC subcarrier of one channel band is arranged at n×100 kHz, whereas the DC subcarrier of the other channel band is arranged at (n+180)×100 kHz. Since the DC subcarrier spacing is 18.000 MHz, the subcarriers overlap. Overlapping subcarriers are rearranged outside the upper channel band. One subcarrier is rearranged. This rearrangement is equivalent to moving one subcarrier except the DC subcarriers toward the carrier center frequency.

The transmission signal of the upper channel band which has undergone the rearrangement becomes asymmetrical with respect to its DC subcarrier. The subcarrier rearrangement makes the guard bandwidth 1.9775 MHz. Hence, the transmission signal having the channel bandwidth of 40 MHz can ensure a guard band of a little less than 5%.

In such a transmission signal, the subcarrier rearrangement is done by moving the subcarriers outward from the carrier center frequency. Since the number of moved subcarriers is only one, the mobile wireless terminal apparatus B can easily be implemented by changing the control of a control unit 100 and a frequency channel separation unit 111.

A fast Fourier transform unit 110 divides the subcarriers including those rearranged in the above-described way into subcarrier signals. The frequency channel separation unit 111 separates the divided subcarrier signals into a reference signal, control channel signals, and data signals in accordance with an instruction from the control unit 100. The mobile wireless terminal apparatus thus receives the assigned subcarriers including the rearranged subcarriers.

The mobile wireless terminal apparatus A whose maximum receivable channel bandwidth is 20 MHz is assigned one of the two continuously arranged 20-MHz channel bands and receives the channel band by defining its DC subcarrier as the reception center frequency. When the lower channel band is assigned, the operation is the same as in normally receiving a signal of a 20-MHz reception bandwidth.

As described above, in the wireless base station apparatus and the mobile wireless terminal apparatuses A and B having the above arrangements, the two continuous 20-MHz channel bands are arranged such that their DC subcarriers are spaced apart from each other by 18.000 MHz in the downlink. The overlapping subcarriers are rearranged outside the channel band. This enables communication using the two adjacent channel bands.

According to the wireless base station apparatus and the mobile wireless terminal apparatuses A and B having the above arrangements, it is possible to prevent any degradation in the reception characteristic of the mobile wireless terminal apparatus A which has the narrow reception channel bandwidth of 20 MHz. Additionally, the mobile wireless terminal apparatus B for receiving a wide bandwidth of 40 MHz can effectively utilize the 40-MHz bandwidth and also implement a change in reception control by only a small modification.

As shown in FIG. 16, a DC subcarrier is arranged in the 40-MHz channel band including two continuous 20-MHz channel bands as shown in FIG. 15. The subcarrier corresponding to the DC subcarrier is rearranged outside. Note that the DC subcarrier is arranged in the channel band where the subcarrier is rearranged. The DC subcarrier is provided at the channel raster, i.e., (n+93)×100 kHz. The control unit 200 and the physical resource assigning unit 204 assign one of the two transmission signals of the 20-MHz channel band to the mobile wireless terminal apparatus A.

When the control unit 200 and the physical resource assigning unit 204 assign the channel band as the reception range, the upper channel band which has undergone the subcarrier rearrangement becomes asymmetrical with respect to the DC subcarrier. However, the asymmetry of the order of two subcarriers allows reception without improving the reception performance of the mobile wireless terminal apparatus. A mobile wireless terminal apparatus assigned the lower channel band performs the same operation as in normally receiving a signal of a 20-MHz reception bandwidth.

The upper channel band and the lower channel band may be interchanged, as a matter of course.

### Example 6

In Example 6, an OFDM cellular system will be exemplified which operates, in a single 100-MHz frequency band, a mobile wireless terminal apparatus A capable of receiving a maximum channel bandwidth of 20 MHz and a mobile wireless terminal apparatus B capable of receiving a channel bandwidth of 100 MHz.

The mobile wireless terminal apparatus A can receive a channel band as shown in FIG. 6. More specifically, 1,200 subcarriers at a subcarrier spacing of 15 kHz are arranged in one transmission signal having a channel bandwidth of 20 MHz transmitted from the wireless base station apparatus. A DC subcarrier is arranged at the center frequency, thereby forming a transmission signal band of 18.015 MHz (the number of subcarriers=1201). Note that the DC subcarrier is not transmitted.

The difference between the channel bandwidth of 20 MHz and the transmission signal band of 18.015 MHz, i.e., 1.985 MHz (0.9925 MHz on each side) serves as a guard band. About 5% of the 20-MHz channel bandwidth is applied on each side. The guard band is not used to transmit signals considering the design of element components such as transmission and reception filters that are hard to obtain ideal characteristics. Note that the system description may regard the transmission bandwidth as 18 MHz and the guard bandwidth as 2 MHz (1 MHz on each side) excluding the DC subcarrier. The transmission signal is divided into RBs (resource blocks) each including 12 subcarriers. The mobile wireless terminal apparatus A is assigned one or more RBs to receive PDSCH within the 20-MHz channel bandwidth. The structure of an RB is the same as in FIG. 4.

FIG. 7 shows an example of the structure of the transmission signal of one subframe. The RBs are arranged in the frequency direction. The transmission signal includes control signals (PCFICH, PDCCH, and PHICH) to transmit control information and information signals (PDSCH) to transmit transmission information. PDSCH in each RB transmits information for a mobile wireless terminal apparatus.

Hence, each mobile wireless terminal apparatus needs to receive only an RB that forms PDSCH for itself. PDCCHs are multiplexed and arranged throughout the signal band. Each PDCCH contains information representing PDSCH assignment to a specific mobile wireless terminal apparatus.

Since the PDCCH arrangement is not fixed, each mobile wireless terminal apparatus must search for a PDCCH addressed to itself. It is therefore necessary to receive the whole signal band, i.e., the transmission signal of the 20-MHz channel bandwidth. FIG. 7 does not illustrate the DC subcarrier which transmits no signal and is therefore insignificant from the viewpoint of transmission of control information and transmission information.

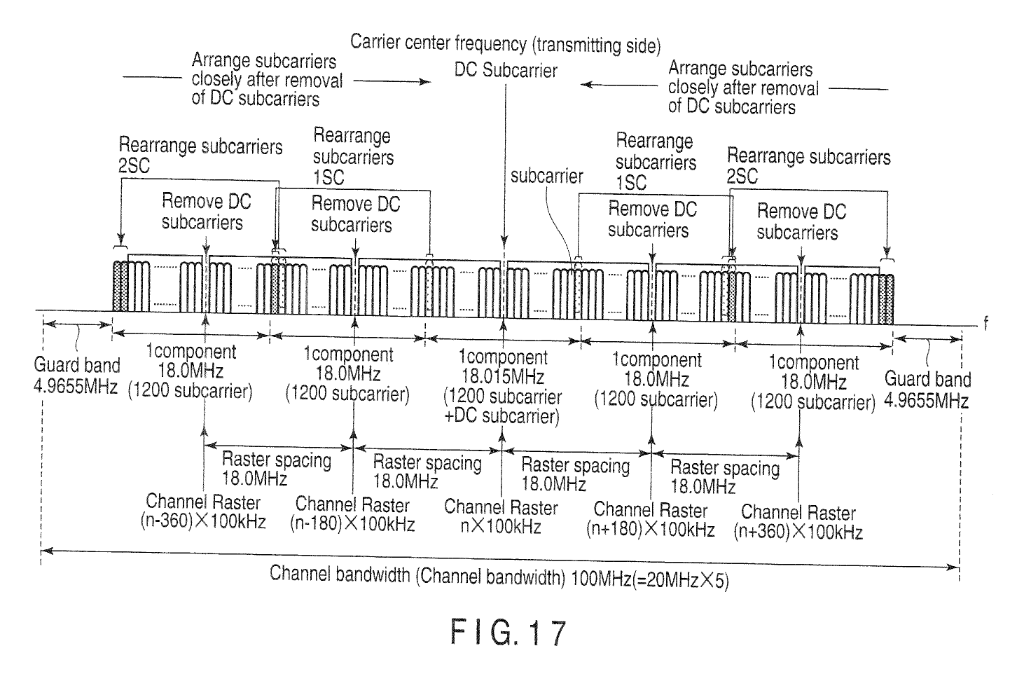

The mobile wireless terminal apparatus B can receive a channel bandwidth of 100 MHz as shown in FIG. 17. The wireless base station apparatus transmits a channel bandwidth of 100 MHz, as shown in FIG. 17. More specifically, the wireless base station apparatus continuously arranges, in the frequency direction, five components each corresponding to a transmission signal having a channel bandwidth of 20 MHz, thereby forming a channel bandwidth of 100 MHz in total. To the mobile wireless terminal apparatus A, a control unit 200 and a physical resource assigning unit 204 assign the middle channel band of the five continuously arranged channel bands as the reception range.

Of the five 20-MHz channel bands, each of the two channel bands adjacent to the middle channel band sets its center at a position spaced apart from the center of the middle channel band by 18.000 MHz considering that the least common multiple of the 100-kHz channel raster and the 15-kHz subcarrier spacing is 300 kHz and that minimum subcarriers overlap those of the middle channel band.

When the carrier center frequency is n×100 kHz, the DC subcarrier used to receive the transmission signal of the 20-MHz channel band adjacent on the lower side is arranged at (n−180)×100 kHz. On the other hand, the DC subcarrier used to receive the transmission signal of the 20-MHz channel band adjacent on the upper side is arranged at (n+180)×100 kHz.

In the two channel bands adjacent to the middle channel band, the DC subcarriers are removed, and the subcarriers are arranged closely. One subcarrier overlapping that of the middle channel band is arranged outside.

In the five 20-MHz channel bands, the centers of the two channel bands at both ends are also located at positions spaced apart from the centers of the adjacent channel bands by 18.000 MHz.

When the carrier center frequency is n×100 kHz, the DC subcarrier used to receive the transmission signal of the channel band at the lower end is arranged at (n−360)×100 kHz. On the other hand, the DC subcarrier used to receive the transmission signal of the channel band at the upper end is arranged at (n+360)×1.00 kHz when the carrier center frequency is n×100 kHz.

At this time, the subcarriers overlap between the 20-MHz channel bands. The overlapping subcarriers are rearranged outside the 20-MHz channel bands on both sides in a direction to separate from the carrier center frequency. When the DC subcarrier spacing is 18.0 MHz, only one subcarrier needs to be rearranged outside in each channel band adjacent to the middle channel band. This rearrangement is equivalent to moving one subcarrier except the DC subcarriers in the direction to separate from the carrier center frequency (transmitting side). In the adjacent channel band at each end, only two subcarriers need to be rearranged outside. This rearrangement is equivalent to moving two subcarriers except the DC subcarriers in the direction to separate from the carrier center frequency (transmitting side).

In the two channel bands on both sides, the DC subcarriers are removed, and the subcarriers are arranged closely. The subcarrier rearrangement makes the guard bandwidth 4.9625 MHz. Hence, the transmission signal having the channel bandwidth of 100 MHz can ensure a guard band of a little less than 5%.

A fast Fourier transform unit 110 divides the subcarriers including those rearranged in the above-described way into subcarrier signals. A frequency channel separation unit 111 separates the divided subcarrier signals into a reference signal, control channel signals, and data signals in accordance with an instruction from a control unit 100. The mobile wireless terminal apparatus thus receives the assigned subcarriers including the rearranged subcarriers.

The mobile wireless terminal apparatus A whose maximum receivable channel bandwidth is 20 MHz is assigned the middle channel band of the five continuously arranged 20-MHz channel bands. Hence, the operation is the same as in normally receiving a signal of a 20-MHz reception bandwidth.

As described above, in the wireless base station apparatus and the mobile wireless terminal apparatuses A and B having the above arrangements, each channel band adjacent to the middle channel band of the five 20-MHz channel bands has its center set at a position spaced apart from that of the middle channel band by 18.000 MHz considering that the least common multiple of the 100-kHz channel raster and the 15-kHz subcarrier spacing is 300 kHz and that minimum subcarriers overlap those of the middle channel band. The DC subcarrier is removed so that the subcarriers are arranged closely, and a subcarrier overlapping that of the middle channel band is rearranged outside. In the channel band at each end as well, the DC subcarrier is removed so that the subcarriers are arranged closely, and subcarriers overlapping those of the middle channel band are rearranged outside. This rearrangement enables communication using the five adjacent channel bands.

According to the wireless base station apparatus and the mobile wireless terminal apparatuses A and B having the above arrangements, it is possible to prevent any degradation in the reception characteristic of the mobile wireless terminal apparatus A which has the narrow reception channel bandwidth of 20 MHz. Additionally, the mobile wireless terminal apparatus B for receiving a wide bandwidth of 100 MHz can effectively utilize the 100-MHz bandwidth and also implement a change in reception control by only a small modification.

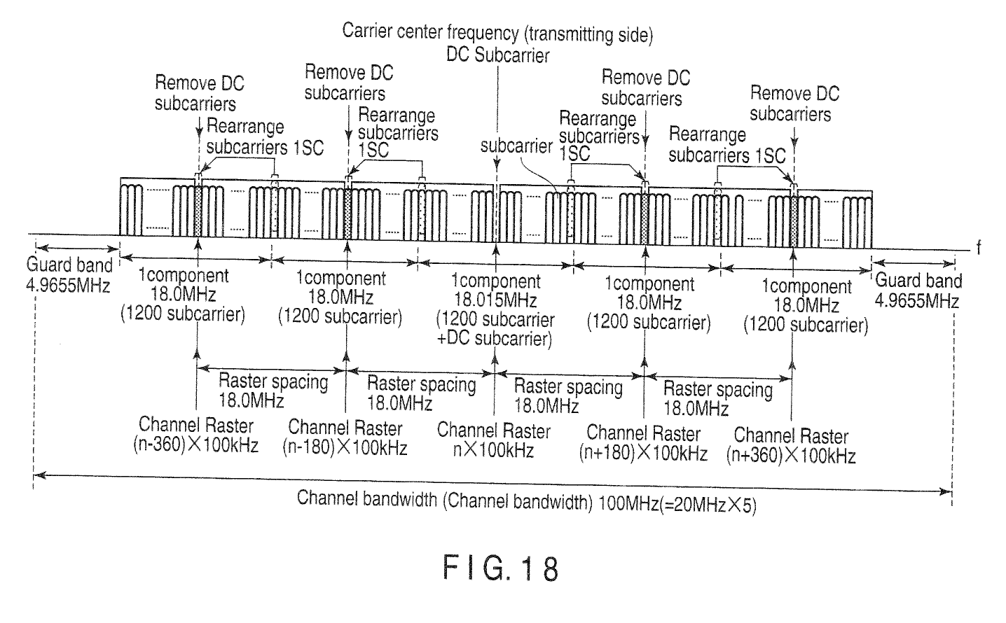

In the above-described example, the subcarrier rearrangement is done as in FIG. 17. However, as shown in FIG. 18, instead of arranging the subcarriers closely, the physical resource assigning unit 204 and the control unit 200 may rearrange one subcarrier adjacent to that of the adjacent channel band at the position of the removed DC subcarrier. Note that to the mobile wireless terminal apparatus A, the control unit 200 and the physical resource assigning unit 204 assign the middle channel band of the five continuously arranged channel bands.

The subcarrier rearrangement also makes the guard bandwidth 4.9625 MHz. Hence, the transmission signal having the channel bandwidth of 100 MHz can ensure a guard band of a little less than 5%.

Note that the present invention is not exactly limited to the above embodiments, and constituent elements can be modified in the stage of practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless base station apparatus which wirelessly communicates with a plurality of mobile wireless terminal apparatuses via channel bands including a plurality of subcarriers, comprising:
a detection unit which detects a communication capability from data received from a mobile wireless terminal apparatus;
a channel assigning unit which selectively assigns, to the mobile wireless terminal apparatus, one or three of a first channel band, a second channel band, and a third channel band in accordance with a detection result of the detection unit; and
a wireless transmission unit which performs wireless transmission to the mobile wireless terminal apparatus via the channel band assigned by the channel assigning unit,
wherein the first channel band is arranged so as to locate a DC subcarrier on a channel raster,
the second channel band is arranged so as to be adjacent to the first channel band from a high frequency side and locate a DC subcarrier on the channel raster while arranging subcarriers in number asymmetrical with respect to the DC subcarrier, and
the third channel band is arranged so as to be adjacent to the first channel band from a low frequency side and locate a DC subcarrier on the channel raster while arranging subcarriers in number asymmetrical with respect to the DC subcarrier.

2. The apparatus according to claim 1, wherein each of the second channel band and the third channel band makes the subcarriers asymmetrical by assigning a larger number of subcarriers on a side of the DC subcarrier close to the first channel band.

3. The apparatus according to claim 1, wherein each of the second channel band and the third channel band makes the subcarriers asymmetrical by assigning a larger number of subcarriers on a side of the DC subcarrier far from the first channel band.

4. The apparatus according to claim 1, wherein the number of subcarriers of the first channel band, the number of subcarriers of the second channel band, and the number of subcarriers of the third channel band are equal.

5. The apparatus according to claim 1, wherein the number of subcarriers of the second channel band and the number of subcarriers of the third channel band are different from the number of subcarriers of the first channel band.

6. The apparatus according to claim 1, wherein subcarriers are arranged at positions of the DC subcarriers of the second channel band and the third channel band.

7. A wireless base station apparatus which wirelessly communicates with a plurality of mobile wireless terminal apparatuses via channel bands including a plurality of subcarriers, comprising:
a detection unit which detects a communication capability from data received from a mobile wireless terminal apparatus;
a channel assigning unit which selectively assigns, to the mobile wireless terminal apparatus, at least one of a first channel band and a second channel band in accordance with a detection result of the detection unit; and
a wireless transmission unit which performs wireless transmission to the mobile wireless terminal apparatus via the channel band assigned by the channel assigning unit,
wherein the first channel band is arranged so as to locate a DC subcarrier on a channel raster, and
the second channel band is arranged so as to be adjacent to the first channel band and locate a DC subcarrier on the channel raster while arranging subcarriers in number asymmetrical with respect to the DC subcarrier.

8. The apparatus according to claim 7, wherein the second channel band makes the subcarriers asymmetrical by assigning a larger number of subcarriers on a side of the DC subcarrier close to the first channel band.

9. The apparatus according to claim 7, wherein the second channel band makes the subcarriers asymmetrical by assigning a larger number of subcarriers on a side of the DC subcarrier far from the first channel band.

10. The apparatus according to claim 7, wherein the number of subcarriers of the first channel band and the number of subcarriers of the second channel band are equal.

11. The apparatus according to claim 7, wherein the number of subcarriers of the second channel band is different from the number of subcarriers of the first channel band.

12. The apparatus according to claim 7, wherein a subcarrier is arranged at a position of the DC subcarrier of the second channel band.

13. The apparatus according to claim 1, further comprising a division unit which divides the channel band assigned by the channel assigning unit into a plurality of resource blocks by putting, from an end of the channel band, every preset number of subcarriers included the channel band together into a resource block.

14. The apparatus according to claim 7, further comprising a division unit which divides the channel band assigned by the channel assigning unit into a plurality of resource blocks by putting, from an end of the channel band, every preset number of subcarriers included the channel band together into a resource block.

15. The apparatus according to claim 13, further comprising a channel arranging unit which, when transmitting an initial synchronization channel to be used for initial synchronization in a band to transmit a resource block including the DC subcarrier out of the resource blocks divided by the division unit, arranges the initial synchronization channel symmetrically with respect to the DC subcarrier.

16. The apparatus according to claim 14, further comprising a channel arranging unit which, when transmitting an initial synchronization channel to be used for initial synchronization in a band to transmit a resource block including the DC subcarrier out of the resource blocks divided by the division unit, arranges the initial synchronization channel symmetrically with respect to the DC subcarrier.

17. A mobile wireless terminal apparatus which performs wireless communication using a channel band including a plurality of subcarriers and assigned by a wireless base station apparatus, comprising:
a detection unit which detects the assigned channel band from data received from the wireless base station apparatus; and
a wireless reception unit which receives a radio signal transmitted from the wireless base station apparatus via one or three of a first channel band, a second channel band, and a third channel band in accordance with a detection result of the detection unit,
wherein the first channel band is arranged so as to locate a DC subcarrier on a channel raster,
the second channel band is arranged on a frequency side higher than the first channel band so as locate a DC subcarrier on the channel raster while arranging subcarriers in number asymmetrical with respect to the DC subcarrier, and
the third channel band is arranged on a frequency side lower than the first channel band so as to locate a DC subcarrier on the channel raster while arranging subcarriers in number asymmetrical with respect to the DC subcarrier.

18. A mobile wireless terminal apparatus which performs wireless communication using a channel band including a plurality of subcarriers and assigned by a wireless base station apparatus, comprising:
a detection unit which detects the assigned channel band from data received from the wireless base station apparatus; and
a wireless reception unit which receives a radio signal transmitted from the wireless base station apparatus via at least one of a first channel band and a second channel band in accordance with a detection result of the detection unit,
wherein the first channel band is arranged so as to locate a DC subcarrier on a channel raster, and
the second channel band is arranged so as to be adjacent to the first channel band and locate a DC subcarrier on the channel raster while arranging subcarriers in number asymmetrical with respect to the DC subcarrier.

19. The apparatus according to claim 17, wherein the channel band to be received by the wireless reception unit is divided into a plurality of resource blocks by putting, from an end of the channel band, every preset number of subcarriers included the channel band together into a resource block.

20. The apparatus according to claim 18, wherein the channel band to be received by the wireless reception unit is divided into a plurality of resource blocks by putting, from an end of the channel band, every preset number of subcarriers included the channel hand together into a resource block.

21. The apparatus according to claim 19, wherein in a band to receive a resource block including the DC subcarrier out of the resource blocks obtained by dividing the channel band to be received by the wireless reception unit, an initial synchronization channel to be used for initial synchronization is arranged symmetrically with respect to the DC subcarrier.

22. The apparatus according to claim 20, wherein in a band to receive a resource block including the DC subcarrier out of the resource blocks obtained by dividing the channel band to be received by the wireless reception unit, an initial synchronization channel to be used for initial synchronization is arranged symmetrically with respect to the DC subcarrier.
